(19) United States
(12) Patent Application Publication
(10) Pub. No.: US 2017/0313821 A1
(43) Pub. Date: Nov. 2, 2017

(54) POLYIMIDE PRECURSOR, POLYIMIDE, AND POLYIMIDE FILM

(71) Applicant: UBE INDUSTRIES, LTD., Ube-shi, Yamaguchi (JP)

(72) Inventors: Takuya OKA, Ube-shi, Yamaguchi (JP); Yukinori KOHAMA, Ube-shi, Yamaguchi (JP); Nobuharu HISANO, Ube-shi, Yamaguchi (JP)

(21) Appl. No.: 15/520,800

(22) PCT Filed: Oct. 23, 2015
(86) PCT No.: PCT/JP2015/080020

§ 371 Date: Apr. 20, 2017

(30) Foreign Application Priority Data
Oct. 23, 2014 (JP) 2014-216695

(51) Int. Cl. C08G 73/10; C08J 5/18

(52) U.S. Cl. CPC C08G 73/1078; C08J 5/18; C08J 2379/08

(57) ABSTRACT

The present invention relates to a polyimide precursor comprising a repeating unit represented by the following chemical formula (1A) and a repeating unit represented by the following chemical formula (2A):

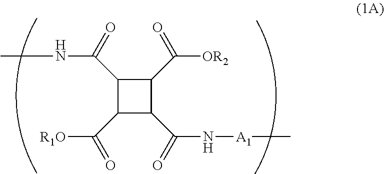

wherein A₁ is a divalent group having an aromatic ring; and R₁ and R₂ are each independently hydrogen, an alkyl group having 1 to 6 carbon atoms, or an alkylsilyl group having 3 to 9 carbon atoms,

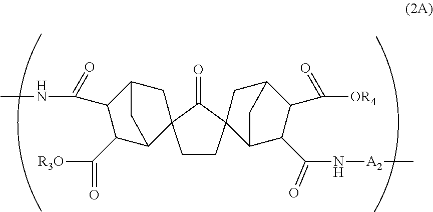

wherein A₂ is a divalent group having an aromatic ring; and R₃ and R₄ are each independently hydrogen, an alkyl group having 1 to 6 carbon atoms, or an alkylsilyl group having 3 to 9 carbon atoms.

### TECHNICAL FIELD

The present invention relates to a polyimide and a polyimide film which have excellent transparency and excellent mechanical properties, and a precursor thereof.

### BACKGROUND ART

With the coming of an advanced information society, the developments of optical materials such as an optical fiber and an optical waveguide in the field of optical communications, and a liquid crystal oriented film and a protective film for a color-filter in the field of display devices have recently advanced. In the field of display devices, in particular, the study of a plastic substrate which is light-weight and excellent in flexibility as an alternative to a glass substrate, and the development of a display which is capable of being bent and rolled have been intensively conducted. In addition, a plastic cover sheet has also been studied as an alternative to a cover glass to protect a display screen. Accordingly, there is need for a higher-performance optical material which may be used for such purposes.

Aromatic polyimides are intrinsically yellowish-brown-colored due to the intramolecular conjugation and the formation of the charge-transfer complex. Accordingly, as a means of reducing coloring, methods of developing transparency, for example, by introducing a fluorine atom into the molecule, imparting flexibility to the main chain, introducing a bulky group as a side chain, or the like to suppress the intramolecular conjugation and the formation of the charge-transfer complex have been proposed.

In addition, methods of developing transparency by the use of a semi-alicyclic or wholly-alicyclic polyimide which do not form a charge-transfer complex in principle have been also proposed. Many semi-alicyclic polyimides using aromatic tetracarboxylic dianhydride as the tetracarboxylic acid component and alicyclic diamine as the diamine component and having high transparency, and many semi-alicyclic polyimides using alicyclic tetracarboxylic dianhydride as the tetracarboxylic acid component and aromatic diamine as the diamine component and having high transparency, in particular, have been proposed.

For example, Non Patent Literature 1 discloses a polyimide in which norbornane-2-spiro-α-cyclopentanone-α′-spiro-2″-norbornane-5,5″,6,6″-tetracarboxylic dianhydride is used as the tetracarboxylic acid component and an aromatic diamine is used as the diamine component. Patent Literatures 1 to 5 also disclose a polyimide in which norbornane-2-spiro-α-cyclopentanone-α′-spiro-2″-norbornane-5,5″,6,6″-tetracarboxylic dianhydride is used as the tetracarboxylic acid component and an aromatic diamine is used as the diamine component.

Patent Literature 6 discloses, as a polyimide precursor from which a polyimide film being colorless and transparent, and having a low coefficient of linear expansion and excellent elongation may be produced, a polyimide precursor which has a structure derived from 2,2′-bis(trifluoromethyl) benzidine (TFMB) as the structure derived from the diamine, and structures derived from pyromellitic dianhydride (PMDA) and 4,4′-oxydiphthalic dianhydride (ODPA) and structures derived from 1,2,3,4-cyclobutane tetracarboxylic dianhydride (CBDA) and/or 1,2,4,5-cyclohexane tetracarboxylic dianhydride (H-PMDA) as the structure derived from the acid dianhydride. Patent Literature 7 discloses a poly(amic acid-imide) copolymer polymerized from 1,2,3,4-cyclobutane tetracarboxylic dianhydride as the tetracarboxylic acid component, and 2,2′-bis(trifluoromethyl)benzidine and a specific imide group-containing diamine as the diamine component.

In some applications, however, a polyimide and a polyimide film which have excellent mechanical properties such as higher modulus of elasticity in addition to excellent transparency are required. For example, both high transparency and high modulus of elasticity are required for a cover sheet to protect a display screen. Additionally, high transparency is required for a substrate for a display, and in the case of a flexible-type display, in particular, high modulus of elasticity may also be required for the substrate in addition to high transparency.

Meanwhile, Patent Literature 8 discloses, as an imide compound useful as a component of a liquid crystal alignment agent, a polyimide in which 1,2,3,4-cyclobutane tetracarboxylic dianhydride is used as the tetracarboxylic acid component and an aromatic diamine such as 4,4′-diaminodiphenylmethane and aniline is used as the diamine component. Patent Literature 9 discloses a liquid crystal alignment agent comprising a polyimide in which 1,2,3,4-cyclobutane tetracarboxylic dianhydride is used as the tetracarboxylic acid component and 2,2′-dimethyl-4,4′-diaminobiphenyl is used as the diamine component.

Meanwhile, Patent Literature 10 discloses a liquid crystal alignment film (polyimide film) which is formed by heating a coating solution obtained by mixing a polyimide precursor (polyamic acid) with an imidazoline compound and/or an imidazole compound. More specifically, a polyimide film is obtained by applying a solution obtained by adding 2,4-dimethylimidazoline to a solution of a polyamic acid obtained from 3,3′,4,4′-benzophenone tetracarboxylic dianhydride and 4,4′-diaminodiphenyl ether (Example 1) or a solution obtained by adding 2-ethylimidazoline and 1,2-dimethylimidazole to a solution of a polyamic acid obtained from pyromellitic dianhydride and 4,4′-diaminodiphenyl ether (Example 2) on a substrate, and then heating the solution.

In addition, as a process for producing an aromatic polyimide which has low transparency, Patent Literature 11 discloses a process for forming a polyimide resin layer, comprising applying a solution containing a polyimide precursor resin, which is obtained by dissolving the polyimide precursor resin and an accelerator for the curing of the polyimide precursor resin such as imidazole and N-methylimidazole in an organic polar solvent, on a substrate, and then subjecting the solution to subsequent heat treatment in which the formation of the polyimide resin layer is completed by drying and imidization in the range of 280° C. to 380° C.

### CITATION LIST

### Patent Literature

Patent Literature 1: WO2011/099518
Patent Literature 2: WO2013/021942
Patent Literature 3: WO2014/034760
Patent Literature 4: WO2013/179727
Patent Literature 5: WO2014/046064
Patent Literature 6: JP-A-2014-139302
Patent Literature 7: JP-A-2005-336243
Patent Literature 8: JP-A-H09-71649
Patent Literature 9: JP-A-2004-109311
Patent Literature 10: JP-A-S61-267030
Patent Literature 11: JP-A-2008-115378

### Non Patent Literature

Non Patent Literature 1: KOUBUNSHI RONBUNSHU (Japanese Journal of Polymer Science and Technology), Vol. 68, No. 3, P. 127-131 (2011)

### SUMMARY OF INVENTION

### Technical Problem

The present invention was made in view of the circumstances as described above, and an object thereof is to provide a polyimide and a polyimide film which have excellent transparency and excellent mechanical properties. An object of the present invention is also to provide a polyimide precursor from which a polyimide having excellent transparency and excellent mechanical properties may be obtained.

### Solution to Problem

The present invention relates to the following items.

[1] A polyimide precursor comprising a repeating unit represented by the following chemical formula (1A) and a repeating unit represented by the following chemical formula (2A):

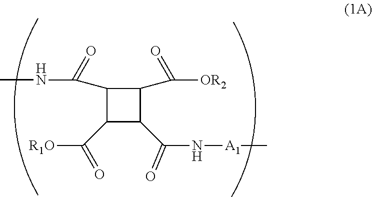

wherein A₁ is a divalent group having an aromatic ring; and R₁ and R₂ are each independently hydrogen, an alkyl group having 1 to 6 carbon atoms, or an alkylsilyl group having 3 to 9 carbon atoms,

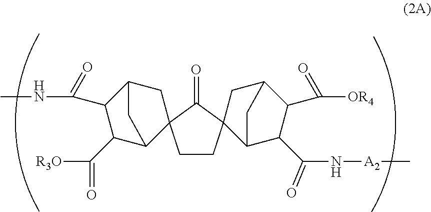

wherein A₂ is a divalent group having an aromatic ring; and R₃ and R₄ are each independently hydrogen, an alkyl group having 1 to 6 carbon atoms, or an alkylsilyl group having 3 to 9 carbon atoms.

[2] The polyimide precursor as described in [1], wherein the total amount of the repeating unit represented by the chemical formula (1A) and the repeating unit represented by the chemical formula (2A) is 90 mol % to 100 mol % relative to the total repeating units.

[3] The polyimide precursor as described in [1] or [2], wherein the amount of the repeating unit represented by the chemical formula (1A) is 10 mol % to 90 mol % relative to the total repeating units, and the amount of the repeating unit represented by the chemical formula (2A) is 10 mol % to 90 mol % relative to the total repeating units.

[4] The polyimide precursor as described in any one of [1] to [3], wherein the polyimide precursor comprises at least one repeating unit of the chemical formula (1A) in which A₁ is a group represented by the following chemical formula (A-1), and comprises at least one repeating unit of the chemical formula (2A) in which A₂ is a group represented by the following chemical formula (A-1):

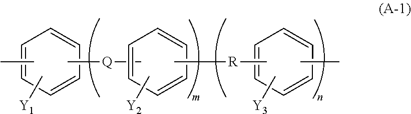

wherein m independently represents 0 to 3 and n independently represents 0 to 3; Y₁, Y₂ and Y₃ each independently represent one selected from the group consisting of hydrogen atom, methyl group and trifluoromethyl group; and Q and R each independently represent direct bond, or one selected from the group consisting of groups represented by the formulas: —NHCO—, —CONH—, —COO— and —OCO—.

[5] The polyimide precursor as described in [4], wherein the total amount of the repeating unit represented by the chemical formula (1A) in which A₁ is a group represented by the chemical formula (A-1) and the repeating unit represented by the chemical formula (2A) in which A₂ is a group represented by the chemical formula (A-1) is 70 mol % to 100 mol % relative to the total repeating units.

[6] A polyimide precursor composition comprising the polyimide precursor as described in any one of [1] to [5].

[7] A polyimide comprising a repeating unit represented by the following chemical formula (1) and a repeating unit represented by the following chemical formula (2):

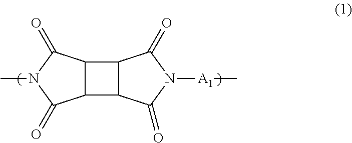

wherein A₁ is a divalent group having an aromatic ring,

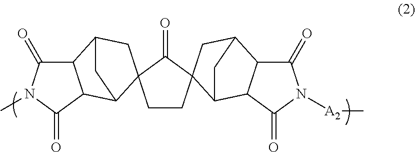

wherein A₂ is a divalent group having an aromatic ring.

[8] The polyimide as described in [7], wherein the total amount of the repeating unit represented by the chemical formula (1) and the repeating unit represented by the chemical formula (2) is 90 mol % to 100 mol % relative to the total repeating units.

[9] The polyimide as described in [7] or [8], wherein the amount of the repeating unit represented by the chemical formula (1) is 10 mol % to 90 mol % relative to the total repeating units, and the amount of the repeating unit represented by the chemical formula (2) is 10 mol % to 90 mol % relative to the total repeating units.

[10] The polyimide as described in any one of [7] to [9], wherein the polyimide comprises at least one repeating unit of the chemical formula (1) in which A₁ is a group represented by the following chemical formula (A-1), and comprises at least one repeating unit of the chemical formula (2) in which A₂ is a group represented by the following chemical formula (A-1):

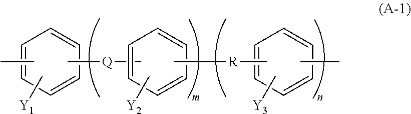

wherein m independently represents 0 to 3 and n independently represents 0 to 3; Y₁, Y₂ and Y₃ each independently represent one selected from the group consisting of hydrogen atom, methyl group and trifluoromethyl group; and Q and R each independently represent direct bond, or one selected from the group consisting of groups represented by the formulas: —NHCO—, —CONH—, —COO— and —OCO—.

[11] The polyimide as described in [10], wherein the total amount of the repeating unit represented by the chemical formula (1) in which A₁ is a group represented by the chemical formula (A-1) and the repeating unit represented by the chemical formula (2) in which A₂ is a group represented by the chemical formula (A-1) is 70 mol % to 100 mol % relative to the total repeating units.

[12] A polyimide obtained from the polyimide precursor as described in any one of [1] to [5], or the polyimide precursor composition as described in [6].

[13] A polyimide film obtained from the polyimide precursor as described in any one of [1] to [5], or the polyimide precursor composition as described in [6].

[14] A film consisting essentially of the polyimide as described in any one of [7] to [12].

[15] A cover sheet for a display screen, comprising the polyimide as described in any one of [7] to [12], or the polyimide film as described in [13] or [14].

[16] A substrate for a display, a touch panel or a solar battery, comprising the polyimide as described in any one of [7] to [12], or the polyimide film as described in [13] or [14].

### Advantageous Effects of Invention

According to the present invention, there may be provided a polyimide and a polyimide film which have excellent transparency and excellent mechanical properties, for example, a tensile modulus of elasticity and a load at break, and the like. In addition, according to the present invention, there may be provided a polyimide precursor from which a polyimide having excellent transparency and excellent mechanical properties, for example, a tensile modulus of elasticity and a load at break, and the like, may be obtained.

The polyimide of the present invention, and the polyimide obtained from the polyimide precursor of the present invention (hereinafter, sometimes collectively referred to as “the polyimide of the present invention”) have high transparency and excellent mechanical properties such as a tensile modulus of elasticity and a load at break. In addition, the polyimide of the present invention usually has a relatively low coefficient of linear thermal expansion. Accordingly, a film consisting essentially of the polyimide of the present invention (the polyimide film of the present invention) may be suitably used, for example, as a cover sheet (protective film) for a display screen, and as a substrate for a display, a touch panel, or a solar battery.

### DESCRIPTION OF EMBODIMENTS

The polyimide precursor of the present invention comprises a repeating unit represented by the chemical formula (1A) and a repeating unit represented by the chemical formula (2A). The polyimide precursor of the present invention, however, may comprise a repeating unit represented by the chemical formula (1A) and a repeating unit represented by the chemical formula (2A) as a whole, and may comprise a polyimide precursor comprising only a repeating unit represented by the chemical formula (1A) and a polyimide precursor comprising only a repeating unit represented by the chemical formula (2A).

The repeating unit represented by the chemical formula (1A) is a repeating unit in which the tetracarboxylic acid component is 1,2,3,4-cyclobutane tetracarboxylic acid, or the like, and the repeating unit represented by the chemical formula (2A) is a repeating unit in which the tetracarboxylic acid component is norbornane-2-spiro-α-cyclopentanone-α′-spiro-2″-norbornane-5,5″,6,6″-tetracarboxylic acid, or the like. A polyimide precursor which consists of a repeating unit in which the tetracarboxylic acid component is 1,2,3,4-cyclobutane tetracarboxylic acid, or the like [a repeating unit represented by the chemical formula (1A)] provides a polyimide which has excellent transparency and excellent mechanical properties, and the YI (yellowness index) of the obtained polyimide film may be reduced and the transparency may be improved, while maintaining the adequate mechanical properties and other properties, by copolymerizing a repeating unit in which the tetracarboxylic acid component is norbornane-2-spiro-α-cyclopentanone-α′-spiro-2″-norbornane-5,5″,6,6″-tetracarboxylic acid, or the like [a repeating unit represented by the chemical formula (2A)], that is, by using norbornane-2-spiro-α-cyclopentanone-α′-spiro-2″-norbornane-5,5″,6,6″-tetracarboxylic acid, or the like as the tetracarboxylic acid component in combination.

The total amount of the repeating unit represented by the chemical formula (1A) and the repeating unit represented by the chemical formula (2A) is preferably 90 mol % to 100 mol %, more preferably 95 mol % to 100 mol %, relative to the total repeating units. In one embodiment, it is particularly preferred that the polyimide precursor of the present invention consists of a repeating unit represented by the chemical formula (1A) and a repeating unit represented by the chemical formula (2A).

As for the polyimide precursor of the present invention, it is preferred that the amount of the repeating unit represented by the chemical formula (1A) is 10 mol % to 90 mol % relative to the total repeating units, and the amount of the repeating unit represented by the chemical formula (2A) is 10 mol % to 90 mol % relative to the total repeating units, and it is more preferred that the amount of the repeating unit represented by the chemical formula (1A) is 30 mol % to 90 mol % relative to the total repeating units, and the amount of the repeating unit represented by the chemical formula (2A) is 10 mol % to 70 mol % relative to the total repeating units, and it is particularly preferred that the amount of the repeating unit represented by the chemical formula (1A) is 50 mol % to 90 mol % relative to the total repeating units, and the amount of the repeating unit represented by the chemical formula (2A) is 10 mol % to 50 mol % relative to the total repeating units.

The polyimide precursor may comprise one type of repeating unit represented by the chemical formula (1A), or comprise at least two types of repeating units represented by the chemical formula (1A) in which A₁ is different, and may comprise one type of repeating unit represented by the chemical formula (2A), or comprise at least two types of repeating units represented by the chemical formula (2A) in which A₂ is different.

The A₁ in the chemical formula (1A) and the A₂ in the chemical formula (2A), that is, the diamine component may be appropriately selected depending on the required properties and the intended use.

As the A₁ in the chemical formula (1A) and the A₂ in the chemical formula (2A), a divalent group having an aromatic ring which has 6 to 40 carbon atoms is preferred, and a group represented by the following chemical formula (A-1) is particularly preferred.

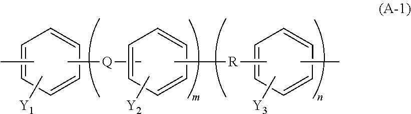

wherein m independently represents 0 to 3 and n independently represents 0 to 3; Y₁, Y₂ and Y₃ each independently represent one selected from the group consisting of hydrogen atom, methyl group and trifluoromethyl group; and Q and R each independently represent direct bond, or one selected from the group consisting of groups represented by the formulas: —NHCO—, —CONH—, —COO— and —OCO—.

It is preferred that in the group represented by the chemical formula (A-1), the aromatic rings are linked at the 4-position relative to the linking group between the aromatic rings, although the linking position of the aromatic rings is not limited thereto.

In one embodiment, as the Aₜ in the chemical formula (1A) and the A₂ in the chemical formula (2A), a group represented by the chemical formula (A-1) in which m and n are 0, or a group represented by the chemical formula (A-1) in which m and/or n is 1 to 3, and Q and R are direct bond is more preferred, and a group represented by any one of the following chemical formulas (D-1) to (D-3) is particularly preferred.

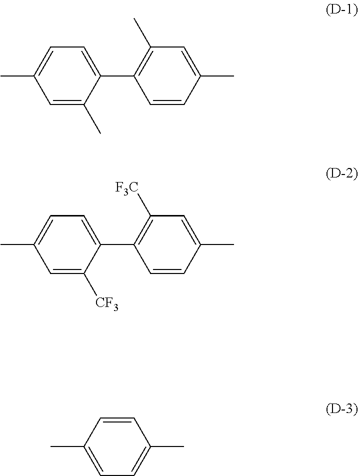

The total amount of the repeating unit represented by the chemical formula (1A) in which A₁ is a group represented by the chemical formula (A-1) and the repeating unit represented by the chemical formula (2A) in which A₂ is a group represented by the chemical formula (A-1) is preferably 70 mol % to 100 mol %, more preferably 80 mol % to 100 mol %, particularly preferably 90 mol % to 100 mol %, relative to the total repeating units.

In one embodiment, the total amount of the repeating unit represented by the chemical formula (1A) in which A₁ is a group represented by any one of the chemical formulas (D-1) to (D-3) and the repeating unit represented by the chemical formula (2A) in which A₂ is a group represented by any one of the chemical formulas (D-1) to (D-3) is preferably 50 mol % to 100 mol %, more preferably 70 mol % to 100 mol %, more preferably 80 mol % to 100 mol %, particularly preferably 90 mol % to 100 mol %, relative to the total repeating units.

As for the polyimide precursor of the present invention, it is preferred that the amount of the repeating unit represented by the chemical formula (1A) in which Aᵢ is a group represented by the chemical formula (A-1) (preferably a group represented by any one of the chemical formulas (D-1) to (D-3)) is 10 mol % to 90 mol % relative to the total repeating units, and the amount of the repeating unit represented by the chemical formula (2A) in which A₂ is a group represented by the chemical formula (A-1) (preferably a group represented by any one of the chemical formulas (D-1) to (D-3)) is 10 mol % to 90 mol % relative to the total repeating units, and it is more preferred that the amount of the repeating unit represented by the chemical formula (1A) in which Aᵢ is a group represented by the chemical formula (A-1) (preferably a group represented by any one of the chemical formulas (D-1) to (D-3)) is 30 mol % to 90 mol % relative to the total repeating units, and the amount of the repeating unit represented by the chemical formula (2A) in which A₂ is a group represented by the chemical formula (A-1) (preferably a group represented by any one of the chemical formulas (D-1) to (D-3)) is 10 mol % to 70 mol % relative to the total repeating units, and it is particularly preferred that the amount of the repeating unit represented by the chemical formula (1A) in which A₁ is a group represented by the chemical formula (A-1) (preferably a group represented by any one of the chemical formulas (D-1) to (D-3)) is 50 mol % to 90 mol % relative to the total repeating units, and the amount of the repeating unit represented by the chemical formula (2A) in which A₂ is a group represented by the chemical formula (A-1) (preferably a group represented by any one of the chemical formulas (D-1) to (D-3)) is 10 mol % to 50 mol % relative to the total repeating units.

The tetracarboxylic acid component to provide a repeating unit represented by the chemical formula (1A) is 1,2,3,4-cyclobutane tetracarboxylic acid, or the like (The term “tetracarboxylic acid, or the like” means tetracarboxylic acid, and tetracarboxylic acid derivatives including tetracarboxylic dianhydride, tetracarboxylic acid silyl ester, tetracarboxylic acid ester and tetracarboxylic acid chloride). The tetracarboxylic acid component to provide a repeating unit represented by the chemical formula (2A) is norbornane-2-spiro-α-cyclopentanone-α′-spiro-2″-norbornane-5,5″,6,6″-tetracarboxylic acid, or the like.

In other words, the polyimide precursor of the present invention is a polyimide precursor obtained from

a tetracarboxylic acid component comprising 1,2,3,4-cyclobutane tetracarboxylic acid, or the like, and norbornane-2-spiro-α-cyclopentanone-α′-spiro-2″-norbornane-5,5″,6,6″-tetracarboxylic acid, or the like; and

a diamine component comprising one or more diamines having an aromatic ring (i.e., aromatic diamine).

As the tetracarboxylic acid component to provide a repeating unit represented by the chemical formula (1A), 1,2,3,4-cyclobutane tetracarboxylic acid, or the like may be used alone or in combination of a plurality of types. As the tetracarboxylic acid component to provide a repeating unit represented by the chemical formula (2A), norbornane-2-spiro-α-cyclopentanone-α′-spiro-2″-norbornane-5,5″,6,6″-tetracarboxylic acid, or the like may be used alone or in combination of a plurality of types. As for norbornane-2-spiro-α-cyclopentanone-α′-spiro-2″-norbornane-5,5″,6,6″-tetracarboxylic acid, or the like, trans-endo-endo-norbornane-2-spiro-α-cyclopentanone-α′-spiro-2″-norbornane-5,5″,6,6″-tetracarboxylic acid, or the like and/or cis-endo-endo-norbornane-2-spiro-α-cyclopentanone-α′-spiro-2″-norbornane-5,5″,6,6″-tetracarboxylic acid, or the like are more preferred.

The diamine component to provide a repeating unit of the chemical formula (1A) and a repeating unit of the chemical formula (2A) is a diamine having an aromatic ring (aromatic diamine), and preferably comprises a diamine to provide a repeating unit of the chemical formula (1A) in which A₁ is a group represented by the chemical formula (A-1) and a repeating unit of the chemical formula (2A) in which A₂ is a group represented by the chemical formula (A-1).

The diamine component to provide a repeating unit of the chemical formula (1A) in which A₁ is a group represented by the chemical formula (A-1) and a repeating unit of the chemical formula (2A) in which A₂ is a group represented by the chemical formula (A-1) has an aromatic ring, and when the diamine component has a plurality of aromatic rings, the aromatic rings are independently linked to each other by direct bond, amide bond, or ester bond. When the aromatic rings are linked at the 4-position relative to the amino group or the linking group between the aromatic rings, the obtained polyimide has a linear structure and may have low linear thermal expansibility, although the linking position of the aromatic rings is not limited thereto. Meanwhile, the aromatic ring may be substituted by methyl or trifluoromethyl. The substitution position is not particularly limited.

Examples of the diamine component to provide a repeating unit of the chemical formula (1A) in which A₁ is a group represented by the chemical formula (A-1) and a repeating unit of the chemical formula (2A) in which A₂ is a group represented by the chemical formula (A-1) include, but not limited to, 2,2′-dimethyl-4,4′-diaminobiphenyl (m-tolidine), p-phenylenediamine, m-phenylenediamine, benzidine, 3,3′-diamino-biphenyl, 2,2′-bis(trifluoromethyl) benzidine, 3,3′-bis(trifluoromethyl) benzidine, 4,4′-diaminobenzanilide, 3,4′-diaminobenzanilide, N,N′-bis(4-aminophenyl)terephthalamide, N,N′-p-phenylene bis(p-aminobenzamide), 4-aminophenoxy-4-diaminobenzoate, bis(4-aminophenyl)terephthalate, biphenyl-4,4′-dicarboxylic acid bis(4-aminophenyl)ester, p-phenylene bis(p-aminobenzoate), bis(4-aminophenyl)-[1,1′-biphenyl]-4,4′-dicarboxylate, and [1,1′-biphenyl]-4,4′-diyl bis(4-aminobenzoate). The diamine component may be used alone or in combination of a plurality of types. Among them, 2,2′-dimethyl-4,4′-diaminobiphenyl, p-phenylenediamine, o-tolidine, 4,4′-diaminobenzanilide, 4-aminophenoxy-4-diaminobenzoate, 2,2′-bis(trifluoromethyl)benzidine, benzidine, N,N′-bis(4-aminophenyl)terephthalamide, and biphenyl-4,4′-dicarboxylic acid bis(4-aminophenyl)ester are preferred, and 2,2′-dimethyl-4,4′-diaminobiphenyl, p-phenylenediamine, 4,4′-diaminobenzanilide, and 2,2′-bis(trifluoromethyl)benzidine are more preferred. These diamines may be used alone or in combination of a plurality of types.

The diamine component to provide a repeating unit of the chemical formula (1A) in which A₁ is a group represented by the chemical formula (D-1) and a repeating unit of the chemical formula (2A) in which A₂ is a group represented by the chemical formula (D-1) is 2,2′-dimethyl-4,4′-diaminobiphenyl. The diamine component to provide a repeating unit of the chemical formula (1A) in which A₁ is a group represented by the chemical formula (D-2) and a repeating unit of the chemical formula (2A) in which A₂ is a group represented by the chemical formula (D-2) is 2,2′-bis(trifluoromethyl)benzidine. The diamine component to provide a repeating unit of the chemical formula (1A) in which A₁ is a group represented by the chemical formula (D-3) and a repeating unit of the chemical formula (2A) in which A₂ is a group represented by the chemical formula (D-3) is p-phenylenediamine.

As the diamine component to provide a repeating unit of the chemical formula (1A) or the chemical formula (2A), other aromatic diamines other than the diamine component which provides the one in which A₁ or A₂ is a structure of the chemical formula (A-1) may be used. Examples of the other diamine component include 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis(4-(4-aminophenoxy)phenyl) hexafluoropropane, 2,2-bis(4-aminophenyl)hexafluoropropane, bis(4-aminophenyl)sulfone, 3,3′-bis(trifluoromethyl)benzidine, 3,3′-bis((aminophenoxy)phenyl)propane, 2,2′-bis(3-amino-4-hydroxyphenyl) hexafluoropropane, bis(4-(4-aminophenoxy)diphenyl)sulfone, bis(4-(3-aminophenoxy)diphenyl)sulfone, octafluorobenzidine, 3,3′-dimethoxy-4,4′-diaminobiphenyl, 3,3′-dichloro-4,4′-diaminobiphenyl, 3,3′-difluoro-4,4′-diaminobiphenyl, 6,6′-bis(3-aminophenoxy)-3,3,3′,3′-tetramethyl-1,1′-spirobiindane, and 6,6′-bis(4-aminophenoxy)-3,3,3′,3′-tetramethyl-1,1′-spirobiindane, and derivatives thereof. These may be used alone or in combination of a plurality of types. Among them, 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 4,4′-bis(4-aminophenoxy)biphenyl, and 4,4′-bis(3-aminophenoxy)biphenyl are preferred, and 4,4′-oxydianiline, and 4,4′-bis(4-aminophenoxy)biphenyl are particularly preferred.

In one embodiment, in view of the properties of the obtained polyimide, the ratio of the diamine component to provide a structure of the chemical formula (A-1) may be preferably, for example, 65 mol % or less, preferably 75 mol % or less, more preferably 80 mol % or less, particularly preferably 90 mol % or less, in total, relative to 100 mol % of the diamine component to provide a repeating unit of the chemical formula (1A) or the chemical formula (2A). For example, other diamines such as a diamine having an ether bond (—O—), including 4,4′-oxydianiline and 4,4′-bis(4-aminophenoxy)biphenyl, may be preferably used, for example, in an amount of 35 mol % or less, preferably 25 mol % or less, more preferably 20 mol % or less, particularly preferably 10 mol % or less, relative to 100 mol % of the diamine component to provide a repeating unit of the chemical formula (1A) or the chemical formula (2A).

The polyimide precursor of the present invention may comprise one or more of other repeating units other than the repeating units represented by the chemical formula (1A) or the chemical formula (2A).

Other aromatic or aliphatic tetracarboxylic acids, or the like may be used as the tetracarboxylic acid component to provide the other repeating unit. Examples thereof include derivatives of, and dianhydrides of 2,2-bis(3,4-dicarboxyphenyl)hexafluoropropane, 4-(2,5-dioxotetrahydrofuran-3-yl)-1,2,3,4-tetrahydronaphthalene-1,2-dicarboxylic acid, pyromellitic acid, 3,3′,4,4′-benzophenone tetracarboxylic acid, 3,3′,4,4′-biphenyl tetracarboxylic acid, 2,3,3′,4′-biphenyl tetracarboxylic acid, 4,4′-oxydiphthalic acid, bis(3,4-dicarboxyphenyl)sulfone dianhydride, m-terphenyl-3,4,3′,4′-tetracarboxylic dianhydride, p-terphenyl-3,4,3′,4′-tetracarboxylic dianhydride, biscarboxyphenyl dimethylsilane, bis dicarboxy phenoxy diphenyl sulfide, sulfonyl diphthalic acid, isopropylidene diphenoxy bis phthalic acid, cyclohexane-1,2,4, 5-tetracarboxylic acid, [1,1′-bi(cyclohexane)]-3,3′,4,4′-tetracarboxylic acid, [1,1′-bi(cyclohexane)]-2,3,3′,4′-tetracarboxylic acid, [1,1′-bi(cyclohexane)]-2,2′,3,3′-tetracarboxylic acid, 4,4′-methylene bis(cyclohexane-1,2-dicarboxylic acid), 4,4′-(propane-2,2-diyl)bis(cyclohexane-1,2-dicarboxylic acid), 4,4′-oxy bis(cyclohexane-1,2-dicarboxylic acid), 4,4′-thio bis(cyclohexane-1,2-dicarboxylic acid), 4,4′-sulfonyl bis(cyclohexane-1,2-dicarboxylic acid), 4,4′-(dimethylsilanediyl)bis(cyclohexane-1,2-dicarboxylic acid), 4,4′-(tetrafluoropropane-2,2-diyl)bis(cyclohexane-1,2-dicarboxylic acid), octahydropentalene-1,3,4,6-tetracarboxylic acid, bicyclo[2.2.1]heptane-2,3,5,6-tetracarboxylic acid, 6-(carboxymethyl)bicyclo[2.2.1]heptane-2,3,5-tricarboxylic acid, bicyclo[2.2.2]octane-2,3,5,6-tetracarboxylic acid, bicyclo[2.2.2]octa-5-ene-2,3,7,8-tetracarboxylic acid, tricyclo[4.2.2.02,5]decane-3,4,7,8-tetracarboxylic acid, tricyclo[4.2.2.02,5]deca-7-ene-3,4,9,10-tetracarboxylic acid, 9-oxatricyclo[4.2.1.02,5]nonane-3,4,7,8-tetracarboxylic acid, and decahydro-1,4:5,8-dimethanonaphthalene-2,3,6, 7-tetracarboxylic acid, and the like. These may be used alone or in combination of a plurality of types.

Additionally, in the case where the diamine component to be combined therewith is an aliphatic diamine, derivatives of, and dianhydrides of 1,2,3,4-cyclobutane tetracarboxylic acid, or the like and norbornane-2-spiro-α-cyclopentanone-α′-spiro-2″-norbornane-5,5″,6,6″-tetracarboxylic acid, or the like may also be used as the tetracarboxylic acid component to provide the other repeating unit.

The diamine component to provide the other repeating unit may be the diamine described as the diamine component to provide a repeating unit of the chemical formula (1A) in which A₁ is a group represented by the chemical formula (A-1) and a repeating unit of the chemical formula (2A) in which A₂ is a group represented by the chemical formula (A-1).

Other aromatic or aliphatic diamines may be used as the diamine component to provide the other repeating unit. Examples thereof include 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis(4-(4-aminophenoxy)phenyl)hexafluoropropane, 2,2-bis(4-aminophenyl) hexafluoropropane, bis(4-aminophenyl)sulfone, 3,3′-bis(trifluoromethyl) benzidine, 3,3′-bis((aminophenoxy)phenyl)propane, 2,2′-bis(3-amino-4-hydroxyphenyl)hexafluoropropane, bis(4-(4-aminophenoxy)diphenyl)sulfone, bis(4-(3-aminophenoxy) diphenyl)sulfone, octafluorobenzidine, 3,3′-dimethoxy-4,4′-diaminobiphenyl, 3,3′-dichloro-4,4′-diaminobiphenyl, 3,3′-difluoro-4,4′-diaminobiphenyl, 1,4-diaminocyclohexane, 1,4-diamino-2-methylcyclohexane, 1,4-diamino-2-ethylcyclohexane, 1,4-diamino-2-n-propylcyclohexane, 1,4-diamino-2-isopropylcyclohexane, 1,4-diamino-2-n-butylcyclohexane, 1,4-diamino-2-isobutylcyclohexane, 1,4-diamino-2-sec-butylcyclohexane, 1,4-diamino-2-tert-butylcyclohexane, 1,2-diaminocyclohexane, 1,3-diaminocyclobutane, 1,4-bis(aminomethyl)cyclohexane, 1,3-bis(aminomethyl) cyclohexane, diaminobicycloheptane, diaminomethylbicycloheptane, diaminooxybicycloheptane, diaminomethyloxybicycloheptane, isophoronediamine, diaminotricyclodecane, diaminomethyltricyclodecane, bis(aminocyclohexyl) methane, bis(aminocyclohexyl)isopropylidene, 6,6′-bis(3-aminophenoxy)-3,3,3′,3′-tetramethyl-1,1′-spirobiindane, and 6,6′-bis(4-aminophenoxy)-3,3,3′,3′-tetramethyl-1,1′-spirobiindane, and derivatives thereof. These may be used alone or in combination of a plurality of types.

The chemical formula (1A) indicates that in a cyclobutane ring, the acid group in either 3-position or 4-position reacts with an amino group to form an amide bond (—CONH—) and the other is a group represented by the formula: —COOR₂, which does not form an amide bond, on the assumption that the acid group in 1-position reacts with an amino group to form an amide bond (—CONH—) and the acid group in 2-position is a group represented by the formula: —COOR₁, which does not form an amide bond. In other words, the chemical formula (1A) includes the two structural isomers.

The chemical formula (2A) indicates that in two norbornane rings (bicyclo[2.2.1]heptane), the acid group in either 5-position or 6-position reacts with an amino group to form an amide bond (—CONH—) and the other is a group represented by the formula: —COOR₃, or a group represented by the formula: —COOR₄, both of which do not form an amide bond. In other words, the chemical formula (2A) includes all of the four structural isomers, that is,

(i) the one having a group represented by the formula: —COOR₃ in the 5-position and a group represented by the formula: —CONH— in the 6-position, and having a group represented by the formula: —COOR₄ in the 5″-position and a group represented by the formula: —CONH-A₂- in the 6″-position;

(ii) the one having a group represented by the formula: —COOR₃ in the 6-position and a group represented by the formula: —CONH— in the 5-position, and having a group represented by the formula: —COOR₄ in the 5″-position and a group represented by the formula: —CONH-A₂- in the 6″-position;

(iii) the one having a group represented by the formula: —COOR₃ in the 5-position and a group represented by the formula: —CONH— in the 6-position, and having a group represented by the formula: —COOR₄ in the 6″-position and a group represented by the formula: —CONH-A₂- in the 5″-position; and

(iv) the one having a group represented by the formula: —COOR₃ in the 6-position and a group represented by the formula: —CONH— in the 5-position, and having a group represented by the formula: —COOR₄ in the 6″-position and a group represented by the formula: —CONH-A₂- in the 5″-position.

In the polyimide precursor of the present invention, R₁ and R₂ in the chemical formula (1A), and R₃ and R₄ in the chemical formula (2A) are each independently hydrogen, an alkyl group having 1 to 6 carbon atoms, preferably having 1 to 3 carbon atoms, or an alkylsilyl group having 3 to 9 carbon atoms. As for R₁ and R₂, and R₃ and R₄, the types of the functional groups and the introduction ratio of the functional groups may be changed by the production method as described later.

In the case where R₁ and R₂, and R₃ and R₄ are hydrogen, a polyimide tends to be easily produced therefrom.

Meanwhile, in the case where R₁ and R₂, and R₃ and R₄ are alkyl group having 1 to 6 carbon atoms, preferably having 1 to 3 carbon atoms, the polyimide precursor tends to have excellent storage stability. In this case, R₁ and R₂, and R₃ and R₄ are more preferably methyl or ethyl.

Additionally, in the case where R₁ and R₂, and R₃ and R₄ are alkylsilyl group having 3 to 9 carbon atoms, the polyimide precursor tends to have excellent solubility. In this case, R₁ and R₂, and R₃ and R₄ are more preferably trimethylsilyl or t-butyldimethylsilyl.

When an alkyl group or an alkylsilyl group is introduced, R₁ and R₂, and R₃ and R₄ each may be converted into an alkyl group or an alkylsilyl group in a ratio of 25% or more, preferably 50% or more, more preferably 75% or more, although the introduction ratio of the functional groups is not limited thereto.

According to the chemical structures which R₁ and R₂, and R₃ and R₄ have, the polyimide precursors of the present invention may be classified into

1) polyamic acid (R₁ and R₂, and R₃ and R₄ are hydrogen),

2) polyamic acid ester (at least part of R₁ and R₂, and R₃ and R₄ is alkyl group), and

3) 4) polyamic acid silyl ester (at least part of R₁ and R₂, and R₃ and R₄ is alkylsilyl group).

Each class of the polyimide precursors of the present invention may be easily produced by the production methods as described below. However, the method for producing the polyimide precursor of the present invention is not limited to the production methods as described below.

1) Polyamic Acid

The polyimide precursor of the present invention may be suitably obtained, in the form of a polyimide precursor solution composition, by reacting a tetracarboxylic dianhydride as a tetracarboxylic acid component and a diamine component in a substantially equimolar amount, preferably in a molar ratio of the diamine component to the tetracarboxylic acid component [molar number of the diamine component/molar number of the tetracarboxylic acid component] of 0.90 to 1.10, more preferably 0.95 to 1.05, in a solvent at a relatively low temperature of 120° C. or less, for example, while suppressing the imidization.

More specifically, the polyimide precursor may be obtained by dissolving the diamine in an organic solvent, adding the tetracarboxylic dianhydride to the resulting solution gradually while stirring the solution, and then stirring the solution at a temperature of 0° C. to 120° C., preferably 5° C. to 80° C., for 1 hour to 72 hours, although the production method is not limited thereto. When they are reacted at a temperature of 80° C. or more, the molecular weight may vary depending on the temperature history in the polymerization and the imidization may proceed by heat, and therefore the polyimide precursor may not be stably produced. The sequence of the addition of the diamine and the tetracarboxylic dianhydride in the production method as described above is preferred because the molecular weight of the polyimide precursor is apt to increase. Meanwhile, the sequence of the addition of the diamine and the tetracarboxylic dianhydride in the production method as described above may be reversed, and the sequence is preferred because the amount of the precipitate is reduced.

In addition, when the diamine component is excessive in the molar ratio of the tetracarboxylic acid component to the diamine component, a carboxylic acid derivative may be added in an amount which substantially corresponds to the excessive molar number of the diamine component, as necessary, so that the molar ratio of the tetracarboxylic acid component to the diamine component is closer to the substantially equimolar amount. As the carboxylic acid derivative to be used herein, tetracarboxylic acids, which do not substantially increase the viscosity of the polyimide precursor solution, that is, do not substantially involve the molecular chain extension, or tricarboxylic acids and anhydrides thereof, and dicarboxylic acids and anhydrides thereof, which function as an end-stopping agent, and the like are preferred.

2) Polyamic Acid Ester

A diester dicarboxylic acid chloride may be obtained by reacting a tetracarboxylic dianhydride and an arbitrary alcohol to provide a diester dicarboxylic acid, and then reacting the diester dicarboxylic acid and a chlorinating agent (thionyl chloride, oxalyl chloride, and the like). The polyimide precursor may be obtained by stirring the diester dicarboxylic acid chloride and a diamine at a temperature of −20° C. to 120° C., preferably −5° C. to 80° C., for 1 hour to 72 hours. When they are reacted at a temperature of 80° C. or more, the molecular weight may vary depending on the temperature history in the polymerization and the imidization may proceed by heat, and therefore the polyimide precursor may not be stably produced. The polyimide precursor may also be easily obtained by dehydrating/condensing a diester dicarboxylic acid and a diamine by the use of a phosphorus-based condensing agent, a carbodiimide condensing agent, or the like.

The polyimide precursor obtained by the method is stable, and therefore the polyimide precursor may be subjected to purification, including reprecipitation in which a solvent such as water and alcohols is added thereto.

3) Polyamic Acid Silyl Ester (Indirect Method)

A silylated diamine may be obtained by reacting a diamine and a silylating agent in advance. The silylated diamine may be purified by distillation, or the like, as necessary. And then, the polyimide precursor may be obtained by dissolving the silylated diamine in a dehydrated solvent, adding a tetracarboxylic dianhydride to the resulting solution gradually while stirring the solution, and then stirring the solution at a temperature of 0° C. to 120° C., preferably 5° C. to 80° C., for 1 hour to 72 hours. When they are reacted at a temperature of 80° C. or more, the molecular weight may vary depending on the temperature history in the polymerization and the imidization may proceed by heat, and therefore the polyimide precursor may not be stably produced.

As for the silylating agent to be used herein, the use of a silylating agent containing no chlorine is preferred because it is unnecessary to purify the silylated diamine. Examples of the silylating agent containing no chlorine atom include N,O-bis(trimethylsilyl)trifluoroacetamide, N,O-bis(trimethylsilyl)acetamide, and hexamethyldisilazane. Among them, N,O-bis(trimethylsilyl)acetamide, and hexamethyldisilazane are particularly preferred, because they contain no fluorine atom and are inexpensive.

In addition, in the silylation reaction of diamine, an amine catalyst such as pyridine, piperidine and triethylamine may be used so as to accelerate the reaction. The catalyst may be used, as it is, as a catalyst for the polymerization of the polyimide precursor.

4) Polyamic Acid Silyl Ester (Direct Method)

The polyimide precursor may be obtained by mixing a polyamic acid solution obtained by the method 1) and a silylating agent, and then stirring the resulting mixture at a temperature of 0° C. to 120° C., preferably 5° C. to 80° C., for 1 hour to 72 hours. When they are reacted at a temperature of 80° C. or more, the molecular weight may vary depending on the temperature history in the polymerization and the imidization may proceed by heat, and therefore the polyimide precursor may not be stably produced.

As for the silylating agent to be used herein, the use of a silylating agent containing no chlorine is preferred because it is unnecessary to purify the silylated polyamic acid, or the obtained polyimide. Examples of the silylating agent containing no chlorine atom include N,O-bis(trimethylsilyl) trifluoroacetamide, N,O-bis(trimethylsilyl)acetamide, and hexamethyldisilazane. Among them, N,O-bis(trimethylsilyl)acetamide, and hexamethyldisilazane are particularly preferred, because they contain no fluorine atom and are inexpensive.

All of the production methods as described above may be suitably performed in an organic solvent, and as a consequence thereof, a solution or a solution composition comprising a polyimide precursor may be easily obtained.

As the solvent used in the production of the polyimide precursor, for example, aprotic solvents such as N,N-dimethylformamide, N,N-dimethylacetamide, N-methyl-2-pyrrolidone, 1,3-dimethyl-2-imidazolidinone and dimethyl sulfoxide are preferred, and N,N-dimethylacetamide is particularly preferred. However, any solvent may be used without any trouble on the condition that the starting monomer components and the formed polyimide precursor can be dissolved in the solvent, and the structure thereof is not limited thereto. Examples of the solvent preferably employed include amide solvents such as N,N-dimethylformamide, N,N-dimethylacetamide and N-methylpyrrolidone; cyclic ester solvents such as γ-butyrolactone, γ-valerolactone, δ-valerolactone, γ-caprolactone, ε-caprolactone and α-methyl-γ-butyrolactone; carbonate solvents such as ethylene carbonate and propylene carbonate; glycol solvents such as triethylene glycol; phenol solvents such as m-cresol, p-cresol, 3-chlorophenol and 4-chlorophenol; acetophenone, 1,3-dimethyl-2-imidazolidinone, sulfolane, and dimethylsulfoxide. In addition, other common organic solvents, namely, phenol, o-cresol, butyl acetate, ethyl acetate, isobutyl acetate, propyleneglycol methyl acetate, ethyl cellosolve, butyl cellosolve, 2-methyl cellosolve acetate, ethyl cellosolve acetate, butyl cellosolve acetate, tetrahydrofuran, dimethoxyethane, diethoxyethane, dibutyl ether, diethylene glycol dimethyl ether, methyl isobutyl ketone, diisobutyl ketone, cyclopentanone, cyclohexanone, methyl ethyl ketone, acetone, butanol, ethanol, xylene, toluene, chlorobenzene, turpentine, mineral spirits, petroleum naphtha-based solvents, and the like may be used. These solvents may be used in combination of a plurality of types.

The logarithmic viscosity of the polyimide precursor in a N,N-dimethylacetamide solution at a concentration of 0.5 g/dL at 30° C. may be preferably 0.2 dL/g or more, more preferably 0.3 dL/g or more, particularly preferably 0.4 dL/g or more, although the logarithmic viscosity of the polyimide precursor is not limited thereto. When the logarithmic viscosity is 0.2 dL/g or more, the molecular weight of the polyimide precursor is high, and therefore the obtained polyimide may have excellent mechanical strength and heat resistance.

The polyimide precursor composition of the present invention usually comprises a polyimide precursor, and a solvent. As the solvent used for the polyimide precursor composition of the present invention, any solvent may be used without any trouble on the condition that the polyimide precursor can be dissolved in the solvent, and the structure thereof is not particularly limited. Examples of the solvent preferably employed include amide solvents such as N,N-dimethylformamide, N,N-dimethylacetamide and N-methyl-2-pyrrolidone; cyclic ester solvents such as γ-butyrolactone, γ-valerolactone, δ-valerolactone, γ-caprolactone, ε-caprolactone and α-methyl-γ-butyrolactone; carbonate solvents such as ethylene carbonate and propylene carbonate; glycol solvents such as triethylene glycol; phenol solvents such as m-cresol, p-cresol, 3-chlorophenol and 4-chlorophenol; acetophenone, 1,3-dimethyl-2-imidazolidinone, sulfolane, and dimethylsulfoxide. In addition, other common organic solvents, namely, phenol, o-cresol, butyl acetate, ethyl acetate, isobutyl acetate, propyleneglycol methyl acetate, ethyl cellosolve, butyl cellosolve, 2-methyl cellosolve acetate, ethyl cellosolve acetate, butyl cellosolve acetate, tetrahydrofuran, dimethoxyethane, diethoxyethane, dibutyl ether, diethylene glycol dimethyl ether, methyl isobutyl ketone, diisobutyl ketone, cyclopentanone, cyclohexanone, methyl ethyl ketone, acetone, butanol, ethanol, xylene, toluene, chlorobenzene, turpentine, mineral spirits, petroleum naphtha-based solvents, and the like may be used. Additionally, these may be used in combination of a plurality of types. The solvent used in the preparation of the polyimide precursor itself may be used as the solvent of the polyimide precursor composition.

In the polyimide precursor composition of the present invention, it is preferred that the total amount of the tetracarboxylic acid component and the diamine component is 5 mass % or more, preferably 10 mass % or more, more preferably 15 mass % or more, relative to the total amount of the solvent, the tetracarboxylic acid component and the diamine component. Additionally, it is generally preferred that the total amount of the tetracarboxylic acid component and the diamine component is 60 mass % or less, preferably 50 mass % or less, relative to the total amount of the solvent, the tetracarboxylic acid component and the diamine component. When the concentration, which is approximate to the concentration of the solid content based on the polyimide precursor, is too low, it may be difficult to control the thickness of the obtained polyimide film in the production of the polyimide film, for example.

Although the viscosity (rotational viscosity) of the polyimide precursor composition is not limited thereto, the rotational viscosity, which is measured with an E-type rotational viscometer at a temperature of 25° C. and at a shearing speed of 20 sec 1, may be preferably 0.01 to 1000 Pa-sec, more preferably 0.1 to 100 Pa-sec. In addition, thixotropy may be imparted, as necessary. When the viscosity is within the above-mentioned range, the composition is easy to handle during the coating or the film formation, and the composition is less repelled and has excellent leveling property, and therefore a good film may be obtained.

The polyimide precursor composition of the present invention may comprise a imidization promoting catalyst (an imidazole compound, and the like), a chemical imidizing agent (an acid anhydride such as acetic anhydride, and an amine compound such as pyridine and isoquinoline), an anti-oxidizing agent, a filler (including an inorganic particle such as silica), a dye, a pigment, a coupling agent such as a silane coupling agent, a primer, a flame retardant, a defoaming agent, a leveling agent, a rheology control agent (flow-promoting agent), a releasing agent, and the like, as necessary.

The polyimide precursor composition of the present invention may preferably comprise an imidazole compound and/or a trialkylamine compound. The amount of the imidazole compound and/or the trialkylamine compound is preferably less than 4 mol, in total, relative to 1 mol of the repeating unit of the polyimide precursor. In the case of a polyimide for which transparency is required, the use of additives which may cause coloring is not desired. However, the mechanical properties of the obtained polyimide film may be improved, while maintaining the high transparency, by adding an imidazole compound and/or a trialkylamine compound to a polyimide precursor composition preferably in a ratio of less than 4 mol, more preferably 0.05 mol to 1 mol, relative to 1 mol of the repeating unit of the polyimide precursor. In other words, a polyimide having better mechanical properties, while maintaining the high transparency, may be obtained from a polyimide precursor having the same composition.

The imidazole compound to be used in the present invention is not particularly limited, on the condition that it is a compound having an imidazole skeleton.

In one embodiment, a compound having a boiling point of less than 340° C., preferably 330° C. or less, more preferably 300° C. or less, particularly preferably 270° C. or less, at 1 atm may be preferably used as the imidazole compound.

Examples of the imidazole compound to be used in the present invention include, but not limited to, 1,2-dimethylimidazole, 1-methylimidazole, 2-methylimidazole, 2-phenylimidazole, imidazole, and benzoimidazole. Among them, 1,2-dimethylimidazole (boiling point at 1 atm: 205° C.), 1-methylimidazole (boiling point at 1 atm: 198° C.), 2-methylimidazole (boiling point at 1 atm: 268° C.), imidazole (boiling point at 1 atm: 256° C.), and the like are preferred, and 1,2-dimethylimidazole and 1-methylimidazole are particularly preferred. The imidazole compound may be used alone or in combination of a plurality of types.

The trialkylamine compound to be used in the present invention may be preferably, but not limited to, a compound having an alkyl group having 1 to 5 carbon atoms, more preferably having 1 to 4 carbon atoms, and examples thereof include trimethylamine, triethylamine, tri-n-propylamine, and tributylamine. The trialkylamine compound may be used alone or in combination of a plurality of types. In addition, one or more imidazole compounds and one or more trialkylamine compounds may be used in combination.

In the case where an imidazole compound and/or a trialkylamine compound is used, the amount of the imidazole compound and/or the trialkylamine compound in the polyimide precursor composition is preferably less than 4 mol relative to 1 mol of the repeating unit of the polyimide precursor. When the amount of the imidazole compound and/or the trialkylamine compound is 4 mol or more relative to 1 mol of the repeating unit of the polyimide precursor, the storage stability of the polyimide precursor composition may be reduced. The amount of the imidazole compound and/or the trialkylamine compound is preferably 0.05 mol or more relative to 1 mol of the repeating unit of the polyimide precursor, and is more preferably 2 mol or less, particularly preferably 1 mol or less, relative to 1 mol of the repeating unit of the polyimide precursor. Herein, 1 mol of the repeating unit of the polyimide precursor corresponds to 1 mol of the tetracarboxylic acid component.

A polyimide precursor composition comprising an imidazole compound and/or a trialkylamine compound may be prepared by adding an imidazole compound and/or a trialkylamine compound to a polyimide precursor solution or solution composition obtained by the production method as described above. Alternatively, a polyimide precursor composition comprising a polyimide precursor, and an imidazole compound and/or a trialkylamine compound may be obtained by adding a tetracarboxylic acid component (a tetracarboxylic dianhydride, or the like), a diamine component, and an imidazole compound and/or a trialkylamine compound to a solvent, and then reacting the tetracarboxylic acid component and the diamine component in the presence of the imidazole compound and/or the trialkylamine compound.

The polyimide of the present invention is the one comprising a repeating unit represented by the chemical formula (1) and a repeating unit represented by the chemical formula (2). In other words, the polyimide of the present invention may be obtained from the polyimide precursor of the present invention, and more specifically, obtained by heating a polyimide precursor composition comprising the polyimide precursor of the present invention.

The polyimide of the present invention may be obtained by imidizing the polyimide precursor of the present invention as described above (i.e., subjecting the polyimide precursor to the dehydration/ring closure reaction). The imidization method is not particularly limited, and any known thermal imidization or chemical imidization method may be suitably applied. Preferred examples of the form of the obtained polyimide include a film, a laminate of a polyimide film and another substrate, a coating film, a powder, a bead, a molded article, and a foamed article.

The polyimide of the present invention is the one obtained using the tetracarboxylic acid component and the diamine component used to obtain the polyimide precursor of the present invention as described above, and the preferred tetracarboxylic acid component and the preferred diamine component are also the same as in the polyimide precursor of the present invention as described above.

The thickness of the film formed of the polyimide obtained from the polyimide precursor of the present invention (the polyimide of the present invention) is generally preferably 5 m to 200 m, more preferably 10 μm to 150 μm, although it varies depending on the intended use. When the polyimide film is too thick, the light transmittance may be low in the case where the polyimide film is used in applications where light passes through the polyimide film, including in display application. When the polyimide film is too thin, the load at break, and the like, may be reduced and the polyimide film may not be suitably used as a film.

It is desirable that a polyimide film has higher transparency when the polyimide film is used in applications where light passes through the polyimide film, including in display application, in particular. The polyimide obtained from the polyimide precursor of the present invention (the polyimide of the present invention) may have preferably, but not limited to, a YI (yellowness index) of 4 or less, more preferably 3.5 or less, more preferably 3 or less, more preferably 2.8 or less, particularly preferably 2.5 or less, when the polyimide is formed into a film.

The polyimide obtained from the polyimide precursor of the present invention (the polyimide of the present invention) may have preferably, but not limited to, a haze of 3% or less, more preferably 2% or less, more preferably 1.5% or less, particularly preferably less than 1%, when the polyimide is formed into a film. In the case where the polyimide film is used in display application, for example, the light may be scattered and the image may be blurred when the haze is as high as more than 3%.

The polyimide obtained from the polyimide precursor of the present invention (the polyimide of the present invention) may have preferably, but not limited to, a light transmittance at 400 nm of 80% or more, more preferably 82% or more, particularly preferably more than 82%, when the polyimide is formed into a film. When the light transmittance is low, the light source must be bright, and therefore a problem of more energy required, or the like may arise in the case where the polyimide is used in display application, or the like.

Mechanical properties are usually required for a polyimide film. The polyimide obtained from the polyimide precursor of the present invention (the polyimide of the present invention) may have preferably, but not limited to, a tensile modulus of elasticity of 4 GPa or more, more preferably 4.5 GPa or more, more preferably 5 GPa or more, more preferably 5.3 GPa or more, more preferably 5.5 GPa or more, particularly preferably 5.8 GPa or more, when the polyimide is formed into a film.

The polyimide obtained from the polyimide precursor of the present invention (the polyimide of the present invention) may have preferably, but not limited to, a load at break of 10 N or more, more preferably 15 N or more, when the polyimide is formed into a film.

The polyimide obtained from the polyimide precursor of the present invention (the polyimide of the present invention) may have preferably, but not limited to, an elongation at break of 2.5% or more, more preferably 3% or more, when the polyimide is formed into a film.

The polyimide obtained from the polyimide precursor of the present invention (the polyimide of the present invention) may have preferably, but not limited to, a coefficient of linear thermal expansion from 100° C. to 250° C. of 45 ppm/K or less, more preferably 40 ppm/K or less, more preferably 35 ppm/K or less, particularly preferably 30 ppm/K or less, when the polyimide is formed into a film. When the coefficient of linear thermal expansion is great, the difference in coefficient of linear thermal expansion between the polyimide and a conductive material such as a metal is great, and therefore a trouble such as an increase in warpage may occur during the formation of a circuit board, for example.

The polyimide obtained from the polyimide precursor of the present invention (the polyimide of the present invention) may have preferably, but not limited to, a 5% weight loss temperature, which is the index of the heat resistance of the polyimide film, of 375° C. or more, more preferably 380° C. or more, more preferably 400° C. or more, particularly preferably 420° C. or more. In the case where a gas barrier film, or the like is formed on the polyimide for the formation of a transistor on the polyimide, or the like, swelling may occur between the polyimide and the barrier film due to outgassing associated with the decomposition of the polyimide when the heat resistance is low.

The polyimide obtained from the polyimide precursor of the present invention (the polyimide of the present invention) has high transparency and excellent mechanical properties such as a tensile modulus of elasticity and a load at break, and has a low coefficient of linear thermal expansion and excellent heat resistance, and therefore may be suitably used, for example, in the application of cover sheet (protective film) for display screen, and in the applications of transparent substrate for display, transparent substrate for touch panel, or substrate for solar battery.

One example of a method for producing a polyimide film/base laminate, or a polyimide film with the use of the polyimide precursor of the present invention will be described below. However, the method is not limited to the method as described below.

A composition comprising the polyimide precursor of the present invention (varnish) is flow-cast on a base, for example, made of ceramic (glass, silicon, alumina, or the like), metal (copper, aluminum, stainless steel, or the like), heat-resistant plastic film (polyimide film, or the like), or the like, and dried at a temperature of 20° C. to 180° C., preferably 20° C. to 150° C., by the use of hot air or infrared ray in a vacuum, in an inert gas such as nitrogen, or in air. And then, the obtained polyimide precursor film is heated and imidized, for example, at a temperature of 200° C. to 500° C., more preferably about 250° C. to about 450° C., by the use of hot air or infrared ray in a vacuum, in an inert gas such as nitrogen, or in air, wherein the polyimide precursor film is on the base, or alternatively, the polyimide precursor film is peeled from the base and fixed at the film edges, to provide a polyimide film/base laminate, or a polyimide film. The thermal imidization is preferably performed in a vacuum or in an inert gas so as to prevent oxidation and degradation of the obtained polyimide film. The thermal imidization may be performed in air if the thermal imidization temperature is not too high.

The imidization reaction of the polyimide precursor may also be performed by chemical treatment in which the polyimide precursor is immersed in a solution containing a dehydrating/cyclizing agent such as acetic anhydride in the presence of a tertiary amine such as pyridine and triethylamine, instead of the thermal imidization by heat treatment as described above. Alternatively, a partially-imidized polyimide precursor may be prepared by adding the dehydrating/cyclizing agent to the polyimide precursor composition (varnish) in advance and stirring the varnish, and then flow-casting the varnish on a base and drying it. A polyimide film/base laminate, or a polyimide film may be obtained by further subjecting the obtained partially-imidized polyimide precursor film to heat treatment as described above, wherein the polyimide precursor film is on the base, or alternatively, the polyimide precursor film is peeled from the base and fixed at the film edges.

As described above, the polyimide film or the polyimide film/base laminate thus obtained may be suitably used for a cover sheet (cover film) for a display, and may also be suitably used for a substrate for a display, a touch panel, a solar battery, or the like. As an example thereof, a substrate comprising the polyimide film of the present invention will be described below.

A flexible conductive substrate may be obtained by forming a conductive layer on one surface or both surfaces of the polyimide film/base laminate or the polyimide film obtained as described above.

A flexible conductive substrate may be obtained by the following methods, for example. As for the first method, the polyimide film is not peeled from the base in the polyimide film/base laminate, and a conductive layer of a conductive material (metal or metal oxide, conductive organic material, conductive carbon, or the like) is formed on the surface of the polyimide film by sputtering, vapor deposition, printing, or the like, to provide a conductive laminate which is a conductive layer/polyimide film/base laminate. And then, as necessary, the conductive layer/polyimide film laminate is peeled from the base, to provide a transparent and flexible conductive substrate which consists of a conductive layer/polyimide film laminate.

As for the second method, the polyimide film is peeled from the base in the polyimide film/base laminate to obtain the polyimide film, and then a conductive layer of a conductive material (metal or metal oxide, conductive organic material, conductive carbon, or the like) is formed on the surface of the polyimide film in the same way as in the first method, to provide a transparent and flexible conductive substrate which consists of a conductive layer/polyimide film laminate, or a conductive layer/polyimide film laminate/conductive layer.

In the first and the second methods, a gas barrier layer against water vapor, oxygen, or the like, and an inorganic layer such as a light-controlling layer may be formed on the surface of the polyimide film by sputtering, vapor deposition, gel-sol process, or the like, as necessary, before the conductive layer is formed.

In addition, a circuit may be suitably formed on the conductive layer by photolithography process, various printing processes, ink-jet process, or the like.

The substrate of the present invention thus obtained has a circuit of a conductive layer on a surface of a polyimide film formed of the polyimide of the present invention, optionally with a gas barrier layer or an inorganic layer therebetween, as necessary. The substrate is flexible, and has high transparency, and excellent mechanical properties, bending resistance and heat resistance, and also has a low coefficient of linear thermal expansion and excellent solvent resistance, and therefore a fine circuit may be easily formed thereon. Accordingly, the substrate may be suitably used as a substrate for a display, a touch panel, or a solar battery.

More specifically, a flexible thin-film transistor is produced by further forming a transistor (inorganic transistor, or organic transistor) on the substrate by vapor deposition, various printing processes, ink-jet process, or the like, and is suitably used as a liquid crystal device for display device, an EL device, or a photoelectric device.

### EXAMPLES

The present invention will be further described below with reference to Examples and Comparative Examples. However, the present invention is not limited to the Examples as described below.

In each of the Examples as described below, the evaluations were conducted by the following methods.

<Evaluation of Polyimide Film>

[Light Transmittance at 400 nm]

The light transmittance at 400 nm of the polyimide film was measured using a UV-visible spectrophotometer V-650DS (made by JASCO Corporation).

[YI]

The YI of the polyimide film was measured in accordance with ASTEM E313 standard using a UV-visible spectrophotometer V-650DS (made by JASCO Corporation). The light source was D65 and the viewing angle was 2°.

[Haze]

The haze of the polyimide film was measured in accordance with JTS K7136 standard using a turbidity meter NDH2000 (made by Nippon Denshoku Industries Co., Ltd.).

[Tensile Modulus of Elasticity, Elongation at Break, Load at Break]

The polyimide film was cut to the dumbbell shape of IEC-540(S) standard, which was used as a test piece (width: 4 mm), and the initial tensile modulus of elasticity, the elongation at break, and the load at break were measured at a distance between chucks of 30 mm and a tensile speed of 2 mm/min using a TENSILON made by Orientec Co., Ltd.

[Coefficient of Linear Thermal Expansion (CTE)]

The polyimide film was cut to a rectangle having a width of 4 mm, which was used as a test piece, and the test piece was heated to 500° C. at a distance between chucks of 15 mm, a load of 2 g and a temperature-increasing rate of 20° C./min using a TMA/SS6100 (made by SII Nanotechnology Inc.). The coefficient of linear thermal expansion from 100° C. to 250° C. was determined from the obtained TMA curve.

[5% Weight Loss Temperature]

The polyimide film was used as a test piece, and the test piece was heated from 25° C. to 600° C. at a temperature-increasing rate of 10° C./min in a flow of nitrogen using a thermogravimetric analyzer (Q5000IR) made by TA Instruments Inc. The 5% weight loss temperature was determined from the obtained weight curve.

[Solvent Resistance Test]

The polyimide film was used as a test piece, and the test piece was immersed in N-methyl-2-pyrrolidone for 1 hour. The one in which a change such as dissolution and white-turbidity of the polyimide film was not observed was evaluated as ∘, and the one in which a change was observed was evaluated as x.

The abbreviations, purities, etc. of the raw materials used in each of the Examples as described below are as follows.

[Diamine Component]

m-TD: 2,2′-dimethyl-4,4′-diaminobiphenyl [purity: 99.85% (GC analysis)]
TFMB: 2,2′-bis(trifluoromethyl)benzidine [purity: 99.83% (GC analysis)]
PPD: p-phenylenediamine [purity: 99.9% (GC analysis)]
4,4′-ODA: 4,4′-oxydianiline [purity: 99.9% (GC analysis)]
BAPB: 4,4′-bis(4-aminophenoxy)biphenyl [purity: 99.93% (HPLC analysis)]
TPE-Q: 1,4-bis(4-aminophenoxy)benzene
TPE-R: 1,3-bis(4-aminophenoxy)benzene

[Tetracarboxylic Acid Component]

CBDA: 1,2,3,4-cyclobutane tetracarboxylic dianhydride [purity: 99.9% (GC analysis)]
CpODA: norbornane-2-spiro-α-cyclopentanone-α′-spiro-2″-norbornane-5,5″,6,6″-tetracarboxylic dianhydride
PMDA: pyromellitic dianhydride
ODPA: 4,4′-oxydiphthalic dianhydride

[Imidazole Compound]

1,2-dimethylimidazole
1-methylimidazole
imidazole

[Solvent]

### DMAc: N,N-dimethylacetamide

The structural formulas of the tetracarboxylic acid components used in Examples and Comparative Examples, the diamine components used in Examples and Comparative Examples, and the imidazole compounds used in Examples and Comparative Examples are shown in Table 1-1, Table 1-2, and Table 1-3, respectively.

TABLE 1-1
Tetracarboxylic dianhydride

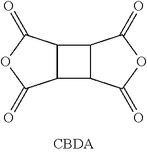 [SMILES: O=C1OC(=O)C2C1C1C(=O)OC(=O)C21]

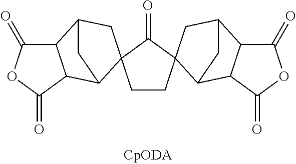 [SMILES: O=C1OC(=O)C2C1C1CC2C2(CCC3(CC4CC3C3C(=O)OC(=O)C43)C2=O)C1]

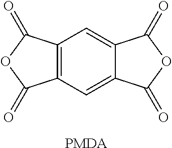

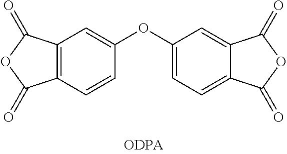 [SMILES: O=C1OC(=O)c2cc(Oc3ccc4c(c3)C(=O)OC4=O)ccc21]

TABLE 1-2
Diamine

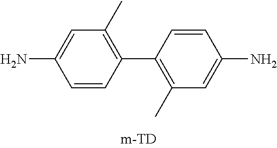 [SMILES: Cc1cc(N)ccc1-c1ccc(N)cc1C]

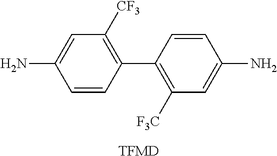

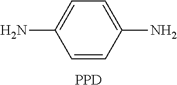

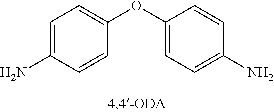 [SMILES: Nc1ccc(Oc2ccc(N)cc2)cc1]

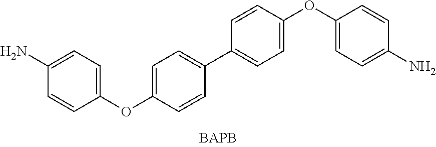 [SMILES: Nc1ccc(Oc2ccc(-c3ccc(Oc4ccc(N)cc4)cc3)cc2)cc1]

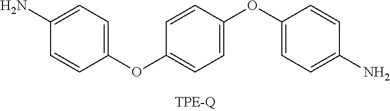 [SMILES: Nc1ccc(Oc2ccc(Oc3ccc(N)cc3)cc2)cc1]

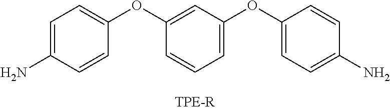 [SMILES: Nc1ccc(Oc2cccc(Oc3ccc(N)cc3)c2)cc1]

TABLE 1-3
Imidazole compound

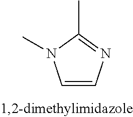

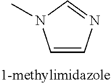

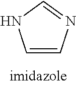

### Example 1

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution. The polyimide precursor solution, which was filtered through a PTFE membrane filter, was applied on a glass substrate, and then the polyimide precursor was thermally imidized by heating the polyimide precursor solution on the glass substrate from room temperature to 300° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 50 μm.

The results of the measurements of the properties of the polyimide film are shown in Table 2-1.

### Example 2

2.12 g (10 mmol) of m-TD was placed in a reaction vessel, which was purged with nitrogen gas, and 24.41 g of DMAc was added thereto such that the total mass of the charged monomers (total mass of the diamine component and the carboxylic acid component) was 16 mass %, and then the mixture was stirred at room temperature for 1 hour. 1.37 g (7 mmol) of CBDA and 1.15 g (3 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example 1, to provide a polyimide film having a thickness of 55 μm.

The results of the measurements of the properties of the polyimide film are shown in Table 2-1.

### Example 3

2.12 g (10 mmol) of m-TD was placed in a reaction vessel, which was purged with nitrogen gas, and 26.38 g of DMAc was added thereto such that the total mass of the charged monomers (total mass of the diamine component and the carboxylic acid component) was 16 mass %, and then the mixture was stirred at room temperature for 1 hour. 0.98 g (5 mmol) of CBDA and 1.92 g (5 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example 1, to provide a polyimide film having a thickness of 54 μm.

The results of the measurements of the properties of the polyimide film are shown in Table 2-1.

### Example 4

2.12 g (10 mmol) of m-TD was placed in a reaction vessel, which was purged with nitrogen gas, and 28.36 g of DMAc was added thereto such that the total mass of the charged monomers (total mass of the diamine component and the carboxylic acid component) was 16 mass %, and then the mixture was stirred at room temperature for 1 hour. 0.59 g (3 mmol) of CBDA and 2.69 g (7 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example 1, to provide a polyimide film having a thickness of 55 μm.

The results of the measurements of the properties of the polyimide film are shown in Table 2-1.

### Comparative Example 1

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example 1, to provide a polyimide film having a thickness of 50 μm.

The results of the measurements of the properties of the polyimide film are shown in Table 2-1.

### Example 5

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish A).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish A) was added to the varnish A, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 50 Mm.

The results of the measurements of the properties of the polyimide film are shown in Table 2-1.

### Example 6

2.12 g (10 mmol) of m-TD) was placed in a reaction vessel, which was purged with nitrogen gas, and 24.41 g of DMAc was added thereto such that the total mass of the charged monomers (total mass of the diamine component and the carboxylic acid component) was 16 mass %, and then the mixture was stirred at room temperature for 1 hour. 1.37 g (7 mmol) of CBDA and 1.15 g (3 mmol) of CpODA were gradually added to the resulting solution. The mixture was stirred at room temperature for 12 hours, to provide a homogeneous and viscous polyimide precursor solution (varnish B).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish B) was added to the varnish B, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 60 μm.

The results of the measurements of the properties of the polyimide film are shown in Table 2-1.

### Example 7

2.12 g (10 mmol) of m-TD was placed in a reaction vessel, which was purged with nitrogen gas, and 26.38 g of DMAc was added thereto such that the total mass of the charged monomers (total mass of the diamine component and the carboxylic acid component) was 16 mass %, and then the mixture was stirred at room temperature for 1 hour. 0.98 g (5 mmol) of CBDA and 1.92 g (5 mmol) of CpODA were gradually added to the resulting solution. The mixture was stirred at room temperature for 12 hours, to provide a homogeneous and viscous polyimide precursor solution (varnish C).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish C) was added to the varnish C, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 61 μm.

The results of the measurements of the properties of the polyimide film are shown in Table 2-1.

### Example 8

2.12 g (10 mmol) of m-TD was placed in a reaction vessel, which was purged with nitrogen gas, and 28.36 g of DMAc was added thereto such that the total mass of the charged monomers (total mass of the diamine component and the carboxylic acid component) was 16 mass %, and then the mixture was stirred at room temperature for 1 hour. 0.59 g (3 mmol) of CBDA and 2.69 g (7 mmol) of CpODA were gradually added to the resulting solution. The mixture was stirred at room temperature for 12 hours, to provide a homogeneous and viscous polyimide precursor solution (varnish D).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish D) was added to the varnish D, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 55 μm.

The results of the measurements of the properties of the polyimide film are shown in Table 2-1.

### Example 9

2.12 g (10 mmol) of m-TD was placed in a reaction vessel, which was purged with nitrogen gas, and 30.34 g of DMAc was added thereto such that the total mass of the charged monomers (total mass of the diamine component and the carboxylic acid component) was 16 mass %, and then the mixture was stirred at room temperature for 1 hour. 0.20 g (1 mmol) of CBDA and 3.46 g (9 mmol) of CpODA were gradually added to the resulting solution. The mixture was stirred at room temperature for 12 hours, to provide a homogeneous and viscous polyimide precursor solution (varnish E).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish E) was added to the varnish E, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 61 μm.

The results of the measurements of the properties of the polyimide film are shown in Table 2-1.

### Example 10

1.49 g (7 mmol) of m-TI) and 0.96 g (3 mmol) of TFMB were placed in a reaction vessel, which was purged with nitrogen gas, and 24.13 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example 1, to provide a polyimide film having a thickness of 57 μm.

The results of the measurements of the properties of the polyimide film are shown in Table 2-2.

### Example 11

1.49 g (7 mmol) of m-TD and 0.32 g (3 mmol) of PPD were placed in a reaction vessel, which was purged with nitrogen gas, and 20.79 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example 1, to provide a polyimide film having a thickness of 62 μm.

The results of the measurements of the properties of the polyimide film are shown in Table 2-2.

### Example 12

1.96 g (9 mmol) of m-TD and 0.20 g (1 mmol) of 4,4′-ODA were placed in a reaction vessel, which was purged with nitrogen gas, and 22.37 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example 1, to provide a polyimide film having a thickness of 50 μm.

The results of the measurements of the properties of the polyimide film are shown in Table 2-2.

### Example 13

1.49 g (7 mmol) of m-TD and 0.96 g (3 mmol) of TFMB were placed in a reaction vessel, which was purged with nitrogen gas, and 24.13 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish F).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish F) was added to the varnish F, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 68 μm.

The results of the measurements of the properties of the polyimide film are shown in Table 2-2.

### Example 14

1.49 g (7 mmol) of m-TD and 0.32 g (3 mmol) of PPD were placed in a reaction vessel, which was purged with nitrogen gas, and 20.79 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish G).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish G) was added to the varnish G, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 72 μm.

The results of the measurements of the properties of the polyimide film are shown in Table 2-2.

### Example 15

1.96 g (9 mmol) of m-TD and 0.20 g (1 mmol) of 4,4′-ODA were placed in a reaction vessel, which was purged with nitrogen gas, and 22.37 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish H).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish H) was added to the varnish H, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 66 μm.

The results of the measurements of the properties of the polyimide film are shown in Table 2-2.

### Example 16

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish I).

0.16 g of 1-methylimidazole and 0.16 g of DMAc were placed in a reaction vessel, and a homogeneous solution was obtained therefrom. All of the solution (2 mmol relative to the molecular weight of the repeating unit of the polyimide precursor in the varnish I) was added to the varnish I, and then the mixture was stirred at room temperature for 30 minutes, to provide a homogeneous and viscous polyimide precursor solution. The amount of 1-methylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 56 μm.

The results of the measurements of the properties of the polyimide film are shown in Table 2-2.

### Example 17

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish J).

0.14 g of imidazole and 0.14 g of DMAc were placed in a reaction vessel, and a homogeneous solution was obtained therefrom. All of the solution (2 mmol relative to the molecular weight of the repeating unit of the polyimide precursor in the varnish J) was added to the varnish J, and then the mixture was stirred at room temperature for 30 minutes, to provide a homogeneous and viscous polyimide precursor solution. The amount of imidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 57 μm.

The results of the measurements of the properties of the polyimide film are shown in Table 2-2.

### Example 18

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish K).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish K) was added to the varnish K, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 57 μm.

The results of the measurements of the properties of the polyimide film are shown in Table 2-2.

### Example 19

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish L).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish L) was added to the varnish L, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 54 μm.

The results of the measurements of the properties of the polyimide film are shown in Table 2-2.

### Reference Example 1

2.12 g (10 mmol) of m-TD was placed in a reaction vessel, which was purged with nitrogen gas, and 31.33 g of DMAc was added thereto such that the total mass of the charged monomers (total mass of the diamine component and the carboxylic acid component) was 16 mass %, and then the mixture was stirred at room temperature for 1 hour. 3.84 g (10 mmol) of CpODA was gradually added to the resulting solution. The mixture was stirred at room temperature for 12 hours, to provide a homogeneous and viscous polyimide precursor solution (varnish M).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish M) was added to the varnish M, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 58 μm.

The results of the measurements of the properties of the polyimide film are shown in Table 2-3.

### Reference Example 2

2.12 g (10 mmol) of m-TD was placed in a reaction vessel, which was purged with nitrogen gas, and 31.33 g of DMAc was added thereto such that the total mass of the charged monomers (total mass of the diamine component and the carboxylic acid component) was 16 mass %, and then the mixture was stirred at room temperature for 1 hour. 3.84 g (10 mmol) of CpODA was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), but cracks appeared in the polyimide layer and a polyimide film having a size enough to evaluate the properties could not be obtained. The thickness of the obtained polyimide film was 50 μm.

### Reference Example 3

2.12 g (10 mmol) of m-TDI was placed in a reaction vessel, which was purged with nitrogen gas, and 31.33 g of DMAc was added thereto such that the total mass of the charged monomers (total mass of the diamine component and the carboxylic acid component) was 16 mass %, and then the mixture was stirred at room temperature for 1 hour. 3.84 g (10 mmol) of CpODA was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 420° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-3.

### Reference Example 4

3.20 g (10 mmol) of TFMB was placed in a reaction vessel, which was purged with nitrogen gas, and 28.16 g of DMAc was added thereto such that the total mass of the charged monomers (total mass of the diamine component and the carboxylic acid component) was 20 mass %, and then the mixture was stirred at room temperature for 1 hour. 3.84 g (10 mmol) of CpODA was gradually added to the resulting solution. The mixture was stirred at room temperature for 12 hours, to provide a homogeneous and viscous polyimide precursor solution (varnish N).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish N) was added to the varnish N, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), but cracks appeared in the polyimide layer and a polyimide film having a size enough to evaluate the properties could not be obtained. The thickness of the obtained polyimide film was 50 μm.

### Reference Example 5

3.20 g (10 mmol) of TFMB was placed in a reaction vessel, which was purged with nitrogen gas, and 28.16 g of DMAc was added thereto such that the total mass of the charged monomers (total mass of the diamine component and the carboxylic acid component) was 20 mass %, and then the mixture was stirred at room temperature for 1 hour. 3.84 g (10 mmol) of CpODA was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), but cracks appeared in the polyimide layer and a polyimide film having a size enough to evaluate the properties could not be obtained. The thickness of the obtained polyimide film was 50 μm.

### Reference Example 6

3.20 g (10 mmol) of TFMB was placed in a reaction vessel, which was purged with nitrogen gas, and 28.16 g of DMAc was added thereto such that the total mass of the charged monomers (total mass of the diamine component and the carboxylic acid component) was 20 mass %, and then the mixture was stirred at room temperature for 1 hour. 3.84 g (10 mmol) of CpODA was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 420° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-3.

### Example 20

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish O).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish O) was added to the varnish O, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 12 μm.

The results of the measurements of the properties of the polyimide film are shown in Table 2-3.

### Example 21

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish P).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish P) was added to the varnish P, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 38 μm.

The results of the measurements of the properties of the polyimide film are shown in Table 2-3.

### Example 22

0.85 g (4 mmol) of m-TD and 1.92 g (6 mmol) of TFMB were placed in a reaction vessel, which was purged with nitrogen gas, and 25.78 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example 1, to provide a polyimide film having a thickness of 40 μm.

The results of the measurements of the properties of the polyimide film are shown in Table 2-4.

### Example 23

0.85 g (4 mmol) of m-TD and 0.65 g (6 mmol) of PPD were placed in a reaction vessel, which was purged with nitrogen gas, and 19.11 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example 1, to provide a polyimide film having a thickness of 55 μm.

The results of the measurements of the properties of the polyimide film are shown in Table 2-4.

### Example 24

0.85 g (4 mmol) of m-TD and 1.92 g (6 mmol) of TFMB were placed in a reaction vessel, which was purged with nitrogen gas, and 25.78 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish Q).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish Q) was added to the varnish Q, and then the mixture was stirred at room temperature for 30 minutes, to provide a homogeneous and viscous polyimide precursor solution. The amount of 1,2-dineethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 51 μm.

The results of the measurements of the properties of the polyimide film are shown in Table 2-4.

### Example 25

0.85 g (4 mmol) of m-TD and 0.65 g (6 mmol) of PPD were placed in a reaction vessel, which was purged with nitrogen gas, and 19.11 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish R).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish R) was added to the varnish R, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 56 μm.

The results of the measurements of the properties of the polyimide film are shown in Table 2-4.

### Comparative Example 2

2.12 g (10 mmol) of m-TD was placed in a reaction vessel, which was purged with nitrogen gas, and 28.57 g of DMAc was added thereto such that the total mass of the charged monomers (total mass of the diamine component and the carboxylic acid component) was 14 mass %, and then the mixture was stirred at room temperature for 1 hour. 0.20 g (1 mmol) of CBDA, 1.09 g (5 mmol) of PMDA and 1.24 g (4 mmol) of ODPA were gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 21 μm.

The results of the measurements of the properties of the polyimide film are shown in Table 2-4.

### Comparative Example 3

2.12 g (10 mmol) of m-TD was placed in a reaction vessel, which was purged with nitrogen gas, and 26.89 g of DMAc was added thereto such that the total mass of the charged monomers (total mass of the diamine component and the carboxylic acid component) was 14 mass %, and then the mixture was stirred at room temperature for 1 hour. 0.98 g (5 mmol) of CBDA, 0.65 g (3 mmol) of PMDA and 0.62 g (2 mmol) of ODPA were gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 19 μm.

The results of the measurements of the properties of the polyimide film are shown in Table 2-4.

### Comparative Example 4

3.14 g (9.8 mmol) of TFMB was placed in a reaction vessel, which was purged with nitrogen gas, and 29.50 g of DMAc was added thereto such that the total mass of the charged monomers (total mass of the diamine component and the carboxylic acid component) was 16 mass %, and then the mixture was stirred at room temperature for 1 hour. 0.20 g (1 mmol) of CBDA, 1.09 g (5 mmol) of PMDA and 1.24 g (4 mmol) of ODPA were gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 20 μm.

The results of the measurements of the properties of the polyimide film are shown in Table 2-4.

### Example 26

1.45 g (6.85 mmol) of m-TD and 0.63 g (3.15 mmol) of 4,4′-ODA were placed in a reaction vessel, which was purged with nitrogen gas, and 22.23 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish S).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish S) was added to the varnish S, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 42 μm.

The results of the measurements of the properties of the polyimide film are shown in Table 2-5.

### Example 27

1.45 g (6.85 mmol) of m-TD and 0.63 g (3.15 mmol) of 4,4′-ODA were placed in a reaction vessel, which was purged with nitrogen gas, and 22.23 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish T).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish T) was added to the varnish T, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor,

The polyimide precursor solution was imidized on a glass substrate, and then the obtained polyimide film was peeled from the glass substrate and dried in the same way as in Example 1, to provide a polyimide film having a thickness of 42 μm.

The results of the measurements of the properties of the polyimide film are shown in Table 2-5.

### Example 28

1.45 g (6.85 mmol) of m-TD and 0.63 g (3.15 mmol) of 4,4′-ODA were placed in a reaction vessel, which was purged with nitrogen gas, and 22.23 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish U).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish U) was added to the varnish U, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 50 μm.

The results of the measurements of the properties of the polyimide film are shown in Table 2-5.

### Example 29

1.77 g (8.00 mmol) of m-TD and 0.74 g (2.00 mmol) of BAPB were placed in a reaction vessel, which was purged with nitrogen gas, and 24.07 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish V).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish V) was added to the varnish V, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 42 μm.

The results of the measurements of the properties of the polyimide film are shown in Table 2-5.

### Example 30

1.77 g (8.00 mmol) of m-TD and 0.74 g (2.00 mmol) of BAPB were placed in a reaction vessel, which was purged with nitrogen gas, and 24.07 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish W).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish W) was added to the varnish W, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 42 μm.

The results of the measurements of the properties of the polyimide film are shown in Table 2-5.

### Example 31

1.77 g (8.00 mmol) of m-TD and 0.74 g (2.00 mmol) of BAPB were placed in a reaction vessel, which was purged with nitrogen gas, and 24.07 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish X).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish X) was added to the varnish X, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 52 μm.

The results of the measurements of the properties of the polyimide film are shown in Table 2-5.

### Example 32

1.61 g (7.60 mmol) of m-TD and 0.70 g (2.40 mmol) of TPE-Q were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish Y).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish Y) was added to the varnish Y, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 44 μm.

The results of the measurements of the properties of the polyimide film are shown in Table 2-5.

### Example 33

1.61 g (7.60 mmol) of m-TD and 0.70 g (2.40 mmol) of TPE-Q were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish Z).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish Z) was added to the varnish Z, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 42 μm.

The results of the measurements of the properties of the polyimide film are shown in Table 2-5.

### Example 34

1.61 g (7.60 mmol) of m-TD and 0.70 g (2.40 mmol) of TPE-Q were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish a).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish a) was added to the varnish a, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 42 μm.

The results of the measurements of the properties of the polyimide film are shown in Table 2-5.

### Example 35

1.61 g (7.60 mmol) of m-TD and 0.70 g (2.40 mmol) of TPE-R were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish b).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish b) was added to the varnish b, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 44 μm.

The results of the measurements of the properties of the polyimide film are shown in Table 2-5.

### Example 36

1.61 g (7.60 mmol) of m-TD and 0.70 g (2.40 mmol) of TPE-R were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish c).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish c) was added to the varnish c, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 42 m.

The results of the measurements of the properties of the polyimide film are shown in Table 2-5.

### Example 37

1.61 g (7.60 mmol) of m-TD and 0.70 g (2.40 mmol) of TPE-R were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish d).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish d) was added to the varnish d, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example 1, to provide a polyimide film having a thickness of 40 m.

The results of the measurements of the properties of the polyimide film are shown in Table 2-5.

TABLE 2-1

| | | | | Exam- | Exam- | Comparative | Exam- | Exam- | Exam- | Exam- | Exam- |
|---|---|---|---|---|---|---|---|---|---|---|---|
| | | Example 1 | Example 2 | ple 3 | ple 4 | Example 1 | ple 5 | ple 6 | ple 7 | ple 8 | ple 9 |
| Dianhydride | CBDA | 9.0 | 7.0 | 5.0 | 3.0 | 10.0 | 9.0 | 7.0 | 5.0 | 3.0 | 1.0 |
| | CpODA | 1.0 | 3.0 | 5.0 | 7.0 | 0 | 1.0 | 3.0 | 5.0 | 7.0 | 9.0 |
| | PMDA | | | | | | | | | | |
| | ODPA | | | | | | | | | | |
| Diamine | m-TD | 10.0 | 10.0 | 10.0 | 10.0 | 10.0 | 10.0 | 10.0 | 10.0 | 10.0 | 10.0 |
| | TFMB | | | | | | | | | | |
| | PPD | | | | | | | | | | |
| | 4,4′-ODA | | | | | | | | | | |
| | BAPB | | | | | | | | | | |
| | TPE-Q | | | | | | | | | | |
| | TPE-R | | | | | | | | | | |
| Additive compound | 1,2-dimethylimidazole | | | | | | 0.2 | 0.2 | 0.2 | 0.2 | 0.2 |
| (equivalent/ | 1-methylimidazole | | | | | | | | | | |
| repeating unit) | imidazole | | | | | | | | | | |

| | | | | | | | | | | |
|---|---|---|---|---|---|---|---|---|---|---|
| Thickness/μm | 50 | 55 | 54 | 55 | 50 | 50 | 60 | 61 | 55 | 61 |
| Tensile modulus of elasticity/GPa | 6.0 | 6.3 | 5.7 | 5.8 | 7.1 | 7.3 | 6.0 | 5.3 | 5.2 | 5.3 |
| Elongation at break/% GL | 1 | 5 | 6 | 7 | 2 | 10 | 10 | 7 | 12 | 6 |
| Load at break/N | 12.4 | 41.1 | 37.2 | 35.4 | 24.5 | 40.7 | 47.5 | 42.2 | 42.9 | 37.6 |
| CTE@100-250° C./ppm · K⁻¹ | 25 | 26 | 29 | 29 | 15 | 13 | 13 | 20 | 23 | 15 |
| Transmittance at 400 nm/% | 85 | 86 | 84 | 83 | 81 | 84 | 84 | 86 | 86 | 87 |
| YI | 2.2 | 2.2 | 2.6 | 3.1 | 4.1 | 2.4 | 2.3 | 1.8 | 1.6 | 1.4 |
| Haze/% | 0.1 | 0.1 | 0.3 | 0.6 | 0.7 | 0.2 | 0.1 | 0.2 | 0.1 | 0.4 |
| 5% weight loss temperature/° C. | 457 | 466 | 467 | 475 | 448 | 463 | 466 | 466 | 473 | 482 |
| Solvent resistance | ◯ | ◯ | ◯ | ◯ | ◯ | ◯ | ◯ | ◯ | ◯ | ◯ |

TABLE 2-2

| | | Example | Example | Example | Example | Exam- | Exam- | Exam- | Exam- | Exam- | Exam- |
|---|---|---|---|---|---|---|---|---|---|---|---|
| | | 10 | 11 | 12 | 13 | ple 14 | ple 15 | ple 16 | ple 17 | ple 18 | ple 19 |
| Dianhydride | CBDA | 9.0 | 9.0 | 9.0 | 9.0 | 9.0 | 9.0 | 9.0 | 9.0 | 9.0 | 9.0 |
| | CpODA | 1.0 | 1.0 | 1.0 | 1.0 | 1.0 | 1.0 | 1.0 | 1.0 | 1.0 | 1.0 |
| | PMDA | | | | | | | | | | |
| | ODPA | | | | | | | | | | |
| Diamine | m-TD | 7.0 | 7.0 | 9.0 | 7.0 | 7.0 | 9.0 | 10.0 | 10.0 | 10.0 | 10.0 |
| | TFMB | 3.0 | | | 3.0 | | | | | | |
| | PPD | | 3.0 | | | 3.0 | | | | | |
| | 4,4′-ODA | | | 1.0 | | | 1.0 | | | | |
| | BAPB | | | | | | | | | | |
| | TPE-Q | | | | | | | | | | |
| | TPE-R | | | | | | | | | | |
| Additive compound | 1,2-dimethylimidazole | | | | 0.2 | 0.2 | 0.2 | | | 0.1 | 0.4 |
| (equivalent/ | 1-methylimidazole | | | | | | | 0.2 | | | |
| repeating unit) | imidazole | | | | | | | | 0.2 | | |

| | | | | | | | | | | |
|---|---|---|---|---|---|---|---|---|---|---|
| Thickness/μm | 57 | 62 | 50 | 68 | 72 | 66 | 56 | 57 | 57 | 54 |
| Tensile modulus of elasticity/GPa | 6.3 | 5.9 | 6.3 | 6.0 | 6.5 | 6.3 | 6.9 | 6.6 | 7.1 | 7.4 |
| Elongation at break/% GL | 4 | 1 | 4 | 9 | 7 | 16 | 6 | 6 | 11 | 9 |
| Load at break/N | 47.8 | 10.2 | 29.7 | 61.0 | 66.1 | 68.1 | 51.1 | 50.3 | 54.9 | 49.7 |
| CTE@100-250° C./ppm · K⁻¹ | 9 | 7 | 26 | 14 | 12 | 18 | 13 | 16 | 19 | 12 |
| Transmittance at 400 nm/% | 80 | 81 | 83 | 83 | 82 | 82 | 84 | 83 | 83 | 82 |
| YI | 4.4 | 3.4 | 3.0 | 3.2 | 3.5 | 3.1 | 2.4 | 3.0 | 2.6 | 3.3 |
| Haze/% | 0.5 | 0.7 | 0.2 | 0.4 | 0.3 | 0.3 | 0.2 | 0.2 | 0.3 | 0.9 |
| 5% weight loss temperature/° C. | 456 | 450 | 458 | 466 | 462 | 466 | 466 | 467 | 470 | 463 |
| Solvent resistance | ◯ | ◯ | ◯ | ◯ | ◯ | ◯ | ◯ | ◯ | ◯ | ◯ |

TABLE 2-3

| | | Reference | Reference | Reference | Reference | Reference | Reference | Example | Example |
|---|---|---|---|---|---|---|---|---|---|
| | | Example 1 | Example 2 | Example 3 | Example 4 | Example 5 | Example 6 | 20 | 21 |
| Dianhydride | CBDA | | | | | | | 9.0 | 9.0 |
| | CpODA | 10.0 | 10.0 | 10.0 | 10.0 | 10.0 | 10.0 | 1.0 | 1.0 |
| | PMDA | | | | | | | | |
| | ODPA | | | | | | | | |
| Diamine | m-TD | 10.0 | 10.0 | 10.0 | | | | 10.0 | 10.0 |
| | TFMB | | | | 10.0 | 10.0 | 10.0 | | |
| | PPD | | | | | | | | |
| | 4,4′-ODA | | | | | | | | |
| | BAPB | | | | | | | | |
| | TPE-Q | | | | | | | | |
| | TPE-R | | | | | | | | |
| Additive compound | 1,2-dimethylimidazole | 0.2 | | | 0.2 | | | 0.2 | 0.2 |
| (equivalent/ | 1-methylimidazole | | | | | | | | |
| repeating unit) | imidazole | | | | | | | | |

| | | | | | | | | |
|---|---|---|---|---|---|---|---|---|
| Thickness/μm | 58 | 50 | 10 | 50 | 50 | 10 | 12 | 38 |
| Tensile modulus of elasticity/GPa | 5.2 | — | 4.4 | — | — | 3.0 | 7.3 | 7.4 |
| Elongation at break/% GL | 10 | — | 30 | — | — | 26 | 5 | 6 |
| Load at break/N | 41.3 | — | 7.0 | — | — | 4.8 | 17.1 | 34.7 |
| CTE@100-250° C./ppm · K⁻¹ | 7 | — | 48 | — | — | 67 | 14 | 22 |
| Transmittance at 400 nm/% | 83 | — | 89 | — | — | 91 | 86 | 85 |
| YI | 2.7 | — | 1.1 | — | — | 0.9 | 1.4 | 1.7 |
| Haze/% | 4.2 | — | 0.2 | — | — | 0.2 | 0.2 | 0.2 |
| 5% weight loss temperature/° C. | 377 | — | 474 | — | — | 481 | 452 | 443 |
| Solvent resistance | ◯ | — | ◯ | — | — | ◯ | ◯ | ◯ |

TABLE 2-4

| | | Example | Example | Example | Example | Comparative | Comparative | Comparative |
|---|---|---|---|---|---|---|---|---|
| | | 22 | 23 | 24 | 25 | Example 2 | Example 3 | Example 4 |
| Dianhydride | CBDA | 9.0 | 9.0 | 9.0 | 9.0 | 1.0 | 5.0 | 1.0 |
| | CpODA | 1.0 | 1.0 | 1.0 | 10 | | | |
| | PMDA | | | | | 5.0 | 3.0 | 5.0 |
| | ODPA | | | | | 4.0 | 2.0 | 4.0 |
| Diamine | m-TD | 4.0 | 4.0 | 4.0 | 4.0 | 10.0 | 10.0 | |
| | TFMB | 6.0 | | 6.0 | | | | 9.8 |
| | PPD | | 6.0 | | 6.0 | | | |
| | 4,4′-ODA | | | | | | | |
| | BAPB | | | | | | | |
| | TPE-Q | | | | | | | |
| | TPE-R | | | | | | | |
| Additive compound | 1,2-dimethylimidazole | | | 0.2 | 0.2 | | | |
| (equivalent/ | 1-methylimidazole | | | | | | | |
| repeating unit) | imidazole | | | | | | | |

| | | | | | | | |
|---|---|---|---|---|---|---|---|
| Thickness/μm | 40 | 55 | 51 | 56 | 21 | 19 | 20 |
| Tensile modulus of elasticity/GPa | 5.6 | 6.7 | 6.2 | 7.4 | 5.5 | 6.5 | 4.3 |
| Elongation at break/% GL | 3 | 3 | 10 | 6 | 28 | 11 | 27 |
| Load at break/N | 20.2 | 32.1 | 41.4 | 55.1 | 24.1 | 17.6 | 16.3 |
| CTE@100-250° C./ppm · K⁻¹ | 20 | 19 | 15 | 22 | 16 | 21 | 12 |
| Transmittance at 400 nm/% | 83 | 83 | 85 | 81 | 1 | 5 | 28 |
| YI | 3.5 | 2.8 | 2.5 | 4.3 | 51.3 | 40.2 | 12.6 |
| Haze/% | 0.2 | 0.6 | 0.1 | 0.3 | 0.2 | 0.1 | 0.3 |
| 5% weight loss temperature/° C. | 453 | 451 | 456 | 457 | 489 | 462 | 556 |
| Solvent resistance | ◯ | ◯ | ◯ | ◯ | ◯ | ◯ | ◯ |

TABLE 2-5

| | | Exam- | Exam- | Exam- | Exam- | Exam- | Exam- | Exam- | Exam- | Exam- | Exam- | Exam- | Exam- |
|---|---|---|---|---|---|---|---|---|---|---|---|---|---|
| | | ple 26 | ple 27 | ple 28 | ple 29 | ple 30 | ple 31 | ple 32 | ple 33 | ple 34 | ple 35 | ple 36 | ple 37 |
| Dianhydride | CBDA | 9.0 | 9.0 | 9.0 | 9.0 | 9.0 | 9.0 | 9.0 | 9.0 | 9.0 | 9.0 | 9.0 | 9.0 |
| | CpODA | 1.0 | 1.0 | 1.0 | 10 | 1.0 | 1.0 | 1.0 | 1.0 | 1.0 | 1.0 | 10 | 1.0 |
| | PMDA | | | | | | | | | | | | |
| | ODPA | | | | | | | | | | | | |
| Diamine | m-TD | 6.85 | 6.85 | 6.85 | 8.0 | 8.0 | 8.0 | 7.6 | 7.6 | 7.6 | 7.6 | 7.6 | 7.6 |
| | TFMB | | | | | | | | | | | | |
| | PPD | | | | | | | | | | | | |
| | 4,4′-ODA | 3.15 | 3.15 | 3.15 | | | | | | | | | |
| | BAPB | | | | 2.0 | 2.0 | 2.0 | | | | | | |
| | TPE-Q | | | | | | | 2.4 | 2.4 | 2.4 | | | |
| | TPE-R | | | | | | | | | | 2.4 | 2.4 | 2.4 |
| Additive | 1,2- | 0.1 | 0.2 | 0.4 | 0.1 | 0.2 | 0.4 | 0.1 | 0.2 | 0.4 | 0.1 | 0.2 | 0.4 |
| compound | dimethylimidazole | | | | | | | | | | | | |
| (equivalent/ | 1-methylimidazole | | | | | | | | | | | | |
| repeating | imidazole | | | | | | | | | | | | |
| unit) | | | | | | | | | | | | | |

| | | | | | | | | | | | | |
|---|---|---|---|---|---|---|---|---|---|---|---|---|
| Thickness/μm | 42 | 42 | 50 | 42 | 42 | 52 | 44 | 42 | 42 | 44 | 42 | 40 |
| Tensile modulus of elasticity/GPa | 5.3 | 6.0 | 6.3 | 5.3 | 5.9 | 5.7 | 5.8 | 6.0 | 5.8 | 5.9 | 6.1 | 6.0 |
| Elongation at break/% GL | 6 | 15 | 19 | 13 | 19 | 17 | 14 | 18 | 19 | 17 | 21 | 22 |
| Load at break/N | 31.5 | 34.8 | 46.7 | 31.7 | 35.8 | 46.5 | 36.6 | 34.7 | 37.0 | 35.5 | 33.8 | 35.3 |
| CTE@100-250° C./ppm · K⁻¹ | — | — | — | — | — | — | — | — | — | — | — | — |
| Transmittance at 400 nm/% | 86 | 84 | 82 | 86 | 84 | 82 | 85 | 84 | 83 | 85 | 84 | 84 |
| YI | 1.8 | 2.2 | 2.9 | 1.7 | 2.1 | 2.9 | 1.9 | 2.1 | 2.2 | 2.1 | 2.2 | 2.4 |
| Haze/% | 0.4 | 0.4 | 0.2 | 0.2 | 0.2 | 0.3 | 0.3 | 0.1 | 0.2 | 0.3 | 0.2 | 0.2 |
| 5% weight loss temperature/° C. | — | — | — | — | — | — | — | — | — | — | — | — |
| Solvent resistance | ◯ | ◯ | ◯ | ◯ | ◯ | ◯ | ◯ | ◯ | ◯ | ◯ | ◯ | ◯ |

### INDUSTRIAL APPLICABILITY

According to the present invention, there may be provided a polyimide and a polyimide film which have excellent transparency and excellent mechanical properties, for example, a tensile modulus of elasticity and a load at break, and the like, and a precursor thereof. The polyimide of the present invention, and the polyimide obtained from the polyimide precursor of the present invention have high transparency and excellent mechanical properties such as a tensile modulus of elasticity and a load at break, and also have a low coefficient of linear thermal expansion; therefore the polyimide may be suitably used, for example, for a cover sheet (protective film) for a display screen, and for a substrate for a display, a touch panel, a solar battery, or the like.

1. A polyimide precursor comprising a repeating unit represented by the following chemical formula (1A) and a repeating unit represented by the following chemical formula (2A): 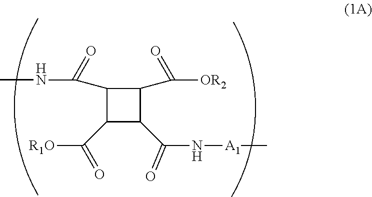
wherein A₁ is a divalent group having an aromatic ring; and R₁ and R₂ are each independently hydrogen, an alkyl group having 1 to 6 carbon atoms, or an alkylsilyl group having 3 to 9 carbon atoms, 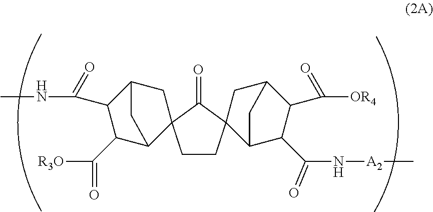
wherein A₂ is a divalent group having an aromatic ring; and R₃ and R₄ are each independently hydrogen, an alkyl group having 1 to 6 carbon atoms, or an alkylsilyl group having 3 to 9 carbon atoms.

2. The polyimide precursor according to claim 1, wherein the total amount of the repeating unit represented by the chemical formula (1A) and the repeating unit represented by the chemical formula (2A) is 90 mol % to 100 mol % relative to the total repeating units.

3. The polyimide precursor according to claim 1, wherein the amount of the repeating unit represented by the chemical formula (1A) is 10 mol % to 90 mol % relative to the total repeating units, and the amount of the repeating unit represented by the chemical formula (2A) is 10 mol % to 90 mol % relative to the total repeating units.

4. The polyimide precursor according to claim 1, wherein the polyimide precursor comprises at least one repeating unit of the chemical formula (1A) in which A₁ is a group represented by the following chemical formula (A-1), and comprises at least one repeating unit of the chemical formula (2A) in which A₂ is a group represented by the following chemical formula (A-1): 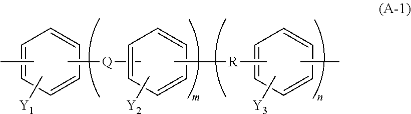
wherein m independently represents 0 to 3 and n independently represents 0 to 3; Y₁, Y₂ and Y₃ each independently represent one selected from the group consisting of hydrogen atom, methyl group and trifluoromethyl group; and Q and R each independently represent direct bond, or one selected from the group consisting of groups represented by the formulas: —NHCO—, —CONH—, —COO— and —OCO—.

5. The polyimide precursor according to claim 4, wherein the total amount of the repeating unit represented by the chemical formula (1A) in which A₁ is a group represented by the chemical formula (A-1) and the repeating unit represented by the chemical formula (2A) in which A₂ is a group represented by the chemical formula (A-1) is 70 mol % to 100 mol % relative to the total repeating units.

6. A polyimide precursor composition comprising the polyimide precursor according to claim 1.

7. A polyimide comprising a repeating unit represented by the following chemical formula (1) and a repeating unit represented by the following chemical formula (2): 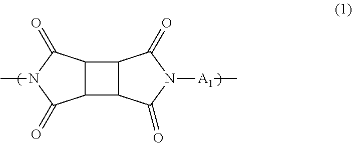
wherein A₁ is a divalent group having an aromatic ring, 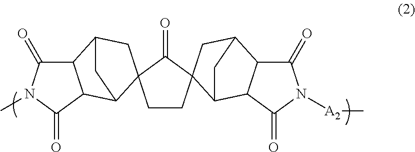
wherein A₂ is a divalent group having an aromatic ring.

8. The polyimide according to claim 7, wherein the total amount of the repeating unit represented by the chemical formula (1) and the repeating unit represented by the chemical formula (2) is 90 mol % to 100 mol % relative to the total repeating units.

9. The polyimide according to claim 7, wherein the amount of the repeating unit represented by the chemical formula (1) is 10 mol % to 90 mol % relative to the total repeating units, and the amount of the repeating unit represented by the chemical formula (2) is 10 mol % to 90 mol % relative to the total repeating units.

10. The polyimide according to claim 7, wherein the polyimide comprises at least one repeating unit of the chemical formula (1) in which A₁ is a group represented by the following chemical formula (A-1), and comprises at least one repeating unit of the chemical formula (2) in which A₂ is a group represented by the following chemical formula (A-1): 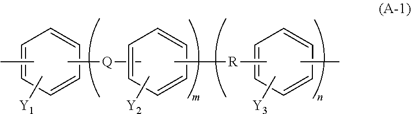
wherein m independently represents 0 to 3 and n independently represents 0 to 3; Y₁, Y₂ and Y₃ each independently represent one selected from the group consisting of hydrogen atom, methyl group and trifluoromethyl group; and Q and R each independently represent direct bond, or one selected from the group consisting of groups represented by the formulas: —NHCO—, —CONH—, —COO— and —OCO—.

11. The polyimide according to claim 10, wherein the total amount of the repeating unit represented by the chemical formula (1) in which A₁ is a group represented by the chemical formula (A-1) and the repeating unit represented by the chemical formula (2) in which A₂ is a group represented by the chemical formula (A-1) is 70 mol % to 100 mol % relative to the total repeating units.

12. A polyimide obtained from the polyimide precursor according to claim 1.

13. A polyimide film obtained from the polyimide precursor according to claim 1.

14. A film consisting essentially of the polyimide according to claim 7.

15. A cover sheet for a display screen, comprising the polyimide according to claim 7.

16. A substrate for a display, a touch panel or a solar battery, comprising the polyimide according to claim 7.

17. A polyimide obtained from a polyimide precursor composition comprising the polyimide precursor according to claim 1.

18. A polyimide film obtained from a polyimide precursor composition comprising the polyimide precursor according to claim 1.
